(19) United States
(12) Patent Application Publication
(10) Pub. No.: US 2014/0198865 A1
(43) Pub. Date: Jul. 17, 2014

(54) OFDM PILOT AND FRAME STRUCTURES

(71) Applicant: QUALCOMM Incorporated, San Diego, CA (US)

(72) Inventors: Christian Pietsch, Nuremberg (DE); Juan Montojo, Nuremberg (DE); Nicola Varanese, Nuremberg (DE); Stefan Brueck, Neunkirchen am Brand (DE); Hendrik Schoeneich, Heroldsberg (DE); Christoph Arnold Joetten, Wadern (DE)

(73) Assignee: QUALCOMM Incorporated, San Diego, CA (US)

(21) Appl. No.: 13/968,270

(22) Filed: Aug. 15, 2013

Related U.S. Application Data
(60) Provisional application No. 61/753,396, filed on Jan. 16, 2013.
(60) Provisional application No. 61/772,303, filed on Mar. 4, 2013.
(60) Provisional application No. 61/773,074, filed on Mar. 5, 2013.

(51) Int. Cl. H04L 27/26

(52) U.S. Cl. CPC H04L 27/261
USPC 375/260

(57) ABSTRACT

A coax network unit (CNU) receives a first plurality of orthogonal frequency-division multiplexing (OFDM) symbols from a coax line terminal (CLT). The first plurality of OFDM symbols includes continual pilot symbols on one or more subcarriers. The CNU also receives a grant from the CLT allocating a set of subcarriers within a second plurality of OFDM symbols to the CNU. The CNU transmits upstream to the CLT using the allocated set of subcarriers within the second plurality of OFDM symbols. When transmitting, the CNU places non-continual pilot symbols on regularly spaced subcarriers of the allocated set of subcarriers and does not place continual pilot symbols within the allocated set of subcarriers.

### RELATED APPLICATIONS

This application claims priority to U.S. Provisional Patent Application No. 61/753,396, titled “Pilot Structure and Frame Structure for an OFDM Transmission Scheme,” filed Jan. 16, 2013; No. 61/772,303, titled “OFDM Pilot and Frame Structures,” filed Mar. 4, 2013; and No. 61/773,074, titled “OFDM Pilot and Frame Structures,” filed Mar. 5, 2013, all of which are hereby incorporated by reference in their entirety.

### TECHNICAL FIELD

The present embodiments relate generally to communication systems, and specifically to pilot symbols in communications using orthogonal frequency-division multiplexing (OFDM).

### BACKGROUND OF RELATED ART

The Ethernet Passive Optical Networks (EPON) protocol may be extended over coaxial (coax) links in a cable plant. The EPON protocol as implemented over coax links is called EPON Protocol over Coax (EPoC). Implementing an EPoC network or similar network over a cable plant presents significant challenges. For example, there is a need for efficient and effective arrangements of pilot symbols to be used to compensate for signal impairments.

### BRIEF DESCRIPTION OF THE DRAWINGS

The present embodiments are illustrated by way of example and are not intended to be limited by the figures of the accompanying drawings.

FIG. 1A is a block diagram of a coaxial network in accordance with some embodiments.

FIG. 1B is a block diagram of a network that includes both optical links and coax links in accordance with some embodiments.

FIG. 2 is a block diagram of a system in which a coax line terminal (CLT) is coupled to a coax network unit (CNU) in accordance with some embodiments.

FIGS. 3A-3D show examples of types of frames or subframes used for transmissions between a CLT and CNUs on a cable plant in accordance with some embodiments.

FIGS. 4A and 4B are examples of the type of frame of FIG. 3A in accordance with some embodiments.

FIGS. 5A and 5B are examples of the type of frame of FIG. 3C in accordance with some embodiments.

FIGS. 6A and 6B show examples of resource blocks in accordance with some embodiments.

FIG. 7A shows an example of pilot symbol placement in a resource block in accordance with some embodiments.

FIG. 7B shows frames generated using resource blocks of the type shown in FIG. 7A in accordance with some embodiments.

FIG. 8A illustrates the use of multiple frame types within OFDMA (sub)frames in accordance with some embodiments.

FIG. 8B shows an example of a mode of operation in which transmissions use continual pilot symbols but not regular pilot symbols in accordance with some embodiments.

FIGS. 8C, 9A, and 9B show examples of modes of operation in which transmissions use continual pilot symbols as well as regular pilot symbols in accordance with some embodiments.

FIG. 10A shows examples of resource blocks that may be used to construct frames or subframes that include regular pilot symbols but not continual pilot symbols in accordance with some embodiments.

FIG. 10B shows examples of resource blocks with different numbers of OFDM symbols in accordance with some embodiments.

FIG. 10C shows frames (or subframes) generated using resource blocks of the type shown in FIGS. 10A and 10B in accordance with some embodiments.

FIGS. 11A-11H show examples of grants with start and end markers as well as regular pilot symbols in accordance with some embodiments.

FIG. 12 shows a frame structure with continual pilot symbols at both edges of the frequency spectrum in accordance with some embodiments.

FIG. 13 shows multiple TDD periods corresponding to a single frame in accordance with some embodiments.

FIGS. 14A-14E show examples of values of pilot symbols in accordance with some embodiments.

FIG. 15 is a flowchart showing a method of communicating between a CLT and a CNU in accordance with some embodiments.

Like reference numerals refer to corresponding parts throughout the drawings and specification.

### DETAILED DESCRIPTION

Arrangements of continual and/or non-continual pilot symbols are disclosed that allow for efficient communication between a coax line terminal (CLT) and coax network units (CNUs).

In some embodiments, a method of communication is performed at a CNU coupled to a CLT. In the method, the CNU receives a first plurality of orthogonal frequency-division multiplexing (OFDM) symbols from the CLT. The first plurality of OFDM symbols includes continual pilot symbols on one or more subcarriers. The CNU also receives a grant from the CLT allocating a set of subcarriers within a second plurality of OFDM symbols to the CNU. The CNU transmits upstream to the CLT using the allocated set of subcarriers within the second plurality of OFDM symbols. When transmitting, the CNU places non-continual pilot symbols on regularly spaced subcarriers of the allocated set of subcarriers and does not place continual pilot symbols within the allocated set of subcarriers.

In some embodiments, a CNU includes a coax physical-layer device (PHY) configured to receive a first plurality of OFDM symbols from a CLT. The first plurality of OFDM symbols includes continual pilot symbols on one or more subcarriers. The PHY is also configured to receive a grant from the CLT allocating a set of subcarriers within a second plurality of OFDM symbols to the CNU, and to transmit upstream to the CLT using the allocated set of subcarriers within the second plurality of OFDM symbols. Within the allocated set of subcarriers, the second plurality of OFDM symbols includes non-continual pilot symbols on regularly spaced subcarriers and excludes continual pilot symbols.

In some embodiments, a method of communication is performed at a CLT coupled to a plurality of CNUs. In the method, the CLT transmits a first plurality of OFDM symbols to the plurality of CNUs. The first plurality of OFDM symbols includes continual pilot symbols on one or more subcarriers. The CLT also transmits grants to the plurality of CNUs allocating respective sets of subcarriers within a second plurality of OFDM symbols to respective CNUs of the plurality of CNUs. The CLT receives the second plurality of OFDM symbols. The allocated sets of subcarriers within the second plurality of OFDM symbols include non-continual pilot symbols on regularly spaced subcarriers and exclude continual pilot symbols.

In some embodiments, a CLT includes a coax PHY configured to transmit a first plurality of OFDM symbols to a plurality of CNUs. The first plurality of OFDM symbols includes continual pilot symbols on one or more subcarriers. The PHY is also configured to transmit grants to the plurality of CNUs allocating respective sets of subcarriers within a second plurality of OFDM symbols to respective CNUs of the plurality of CNUs, and to receive the second plurality of OFDM symbols. The allocated sets of subcarriers within the second plurality of OFDM symbols include non-continual pilot symbols on regularly spaced subcarriers and exclude continual pilot symbols.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

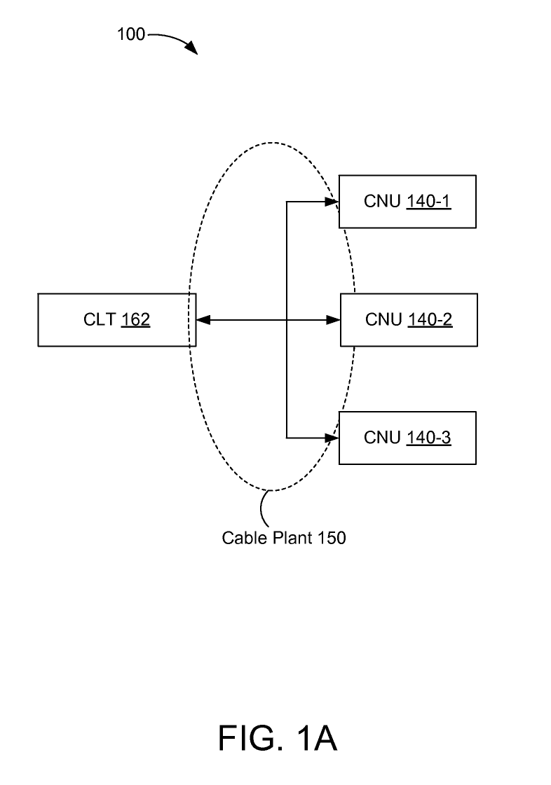

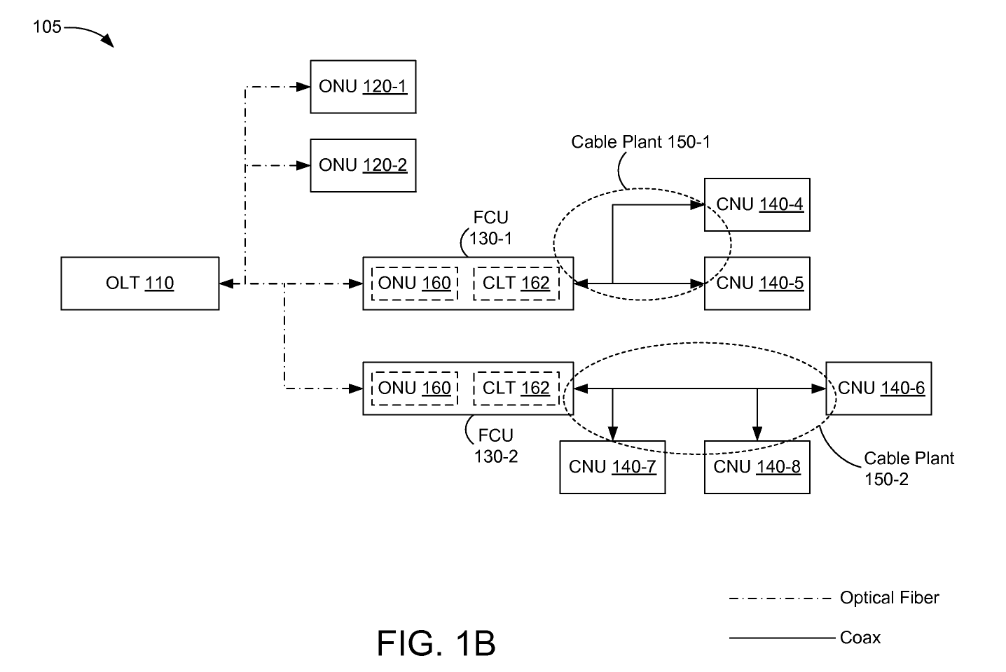

FIG. 1A is a block diagram of a coax network 100 (e.g., an EPoC network) in accordance with some embodiments. The network 100 includes a coax line terminal (CLT) 162 (also referred to as a coax link terminal) coupled to a plurality of coax network units (CNUs) 140-1, 140-2, and 140-3 via coax links. A respective coax link may be a passive coax cable, or may also include one or more amplifiers and/or equalizers, and may run through one or more splitters and/or taps. The coax links compose a cable plant 150. In some embodiments, the CLT 162 is located at the headend of the cable plant 150 and the CNUs 140 are located at the premises of respective users. Alternatively, the CLT 162 is located within the cable plant 150.

The CLT 162 transmits downstream signals to the CNUs 140-1, 140-2, and 140-3 and receives upstream signals from the CNUs 140-1, 140-2, and 140-3. In some embodiments, each CNU 140 receives every packet transmitted by the CLT 162 and discards packets that are not addressed to it. The CNUs 140-1, 140-2, and 140-3 transmit upstream signals using coax resources specified by the CLT 162. For example, the CLT 162 transmits control messages (e.g., GATE messages) to the CNUs 140-1, 140-2, and 140-3 specifying respective future times at which and respective frequencies on which respective CNUs 140 may transmit upstream signals. The bandwidth allocated to a respective CNU by a control message may be referred to as a grant. In some embodiments, the downstream and upstream signals are transmitted using orthogonal frequency-division multiplexing (OFDM). For example, the upstream signals are orthogonal frequency-division multiple access (OFDMA) signals and the downstream signals include different groups of subcarriers directed to different CNUs 140-1, 140-2, and 140-3.

In some embodiments, the CLT 162 is part of a fiber-coax unit (FCU) 130 that is also coupled to an optical line terminal (OLT) 110, as shown in FIG. 1B. FIG. 1B is a block diagram of a network 105 that includes both optical links and coax links in accordance with some embodiments. In the network 105, the OLT 110 (also referred to as an optical link terminal) is coupled to a plurality of optical network units (ONUs) 120-1 and 120-2 via respective optical fiber links. The OLT 110 also is coupled to a plurality of fiber-coax units (FCUs) 130-1 and 130-2 via respective optical fiber links. FCUs are also referred to as optical-coax units (OCUs).

In some embodiments, each FCU 130-1 and 130-2 includes an ONU 160 coupled with a CLT 162. The ONU 160 receives downstream packet transmissions from the OLT 110 and provides them to the CLT 162, which forwards the packets to the CNUs 140 (e.g., CNUs 140-4 and 140-5, or CNUs 140-6 through 140-8) on its cable plant 150 (e.g., cable plant 150-1 or 150-2). In some embodiments, the CLT 162 filters out packets that are not addressed to CNUs 140 on its cable plant 150 and forwards the remaining packets to the CNUs 140 on its cable plant 150. The CLT 162 also receives upstream packet transmissions from CNUs 140 on its cable plant 150 and provides these to the ONU 160, which transmits them to the OLT 110. The ONUs 160 thus receive optical signals from and transmit optical signals to the OLT 110, and the CLTs 162 receive electrical signals from and transmit electrical signals to CNUs 140.

In the example of FIG. 1B, the first FCU 130-1 communicates with CNUs 140-4 and 140-5 (e.g., using OFDMA), and the second FCU 130-2 communicates with CNUs 140-6, 140-7, and 140-8 (e.g., using OFDMA). The coax links coupling the first FCU 130-1 with CNUs 140-4 and 140-5 compose a first cable plant 150-1. The coax links coupling the second FCU 130-2 with CNUs 140-6 through 140-8 compose a second cable plant 150-2. A respective coax link may be a passive coax cable, or alternately may include one or more amplifiers and/or equalizers, and may run through one or more splitters and/or taps. In some embodiments, the OLT 110, ONUs 120-1 and 120-2, and optical portions of the FCUs 130-1 and 130-2 are implemented in accordance with the Ethernet Passive Optical Network (EPON) protocol.

In some embodiments, the OLT 110 is located at a network operator's headend, the ONUs 120 and CNUs 140 are located at the premises of respective users, and the FCUs 130 are located at the headends of their respective cable plants 150 or within their respective cable plants 150.

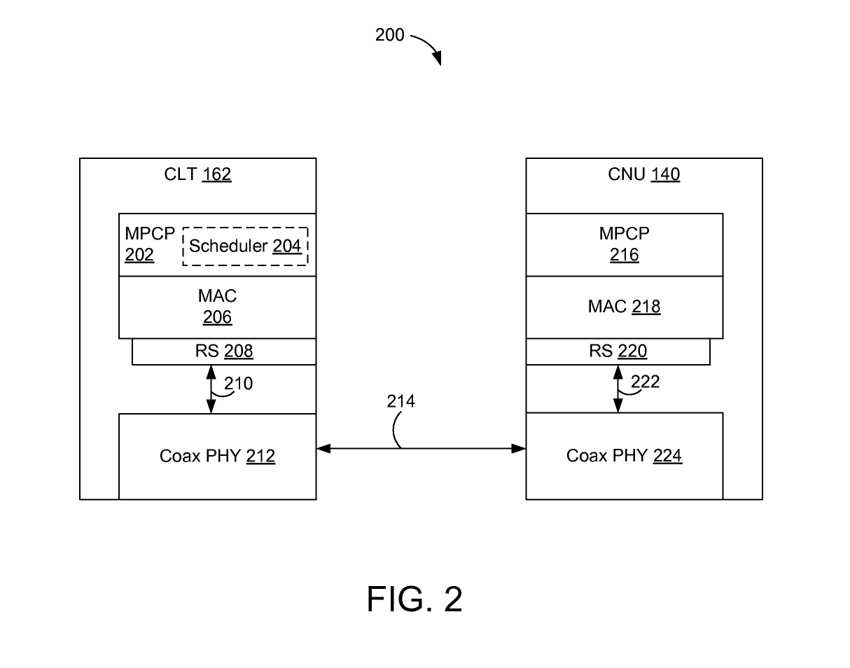

FIG. 2 is a block diagram of a system 200 in which a CLT 162 is coupled to a CNU 140 (e.g., one of the CNUs 140-1 through 140-8, FIGS. 1A-1B) by a coax link 214 (e.g., in a cable plant 150, such as the cable plant 150-1 or 150-2, FIGS. 1A-1B) in accordance with some embodiments. The CLT 162 and CNU 140 communicate via the coax link 214. The coax link 214 couples a coax physical-layer device (PHY) 212 in the CLT 162 to a coax PHY 224 in the CNU 140.

The coax PHY 212 in the CLT 162 is coupled to a media access controller (MAC) 206 (e.g., a full-duplex MAC) by a media-independent interface 210 (e.g., an XGMII) and a reconciliation sublayer (RS) 208. In some embodiments, the media-independent interface 210 continuously conveys signals from the MAC 206 to the PHY 212 (e.g., at a fixed rate) and also continuously conveys signals from the PHY 212 to the MAC 206 (e.g., at the fixed rate). The MAC 206 is coupled to a multi-point control protocol (MPCP) implementation 202, which includes a scheduler 204 that schedules downstream and upstream transmissions.

The coax PHY 224 in the CNU 140 is coupled to a MAC 218 (e.g., a full-duplex MAC) by a media-independent interface 222 and an RS 220. The MAC 218 is coupled to an MPCP implementation 216 that communicates with the MPCP implementation 202 to schedule upstream transmissions (e.g., by sending REPORT messages to the MPCP 202 implementation and receiving GATE messages in response).

In some embodiments, the MPCP implementations 202 and 216 are implemented as distinct sub-layers in the respective protocol stacks of the CLT 162 and CNU 140. In other embodiments, the MPCP implementations 202 and 216 are respectively implemented in the same layers or sub-layers as the MACs 206 and 218.

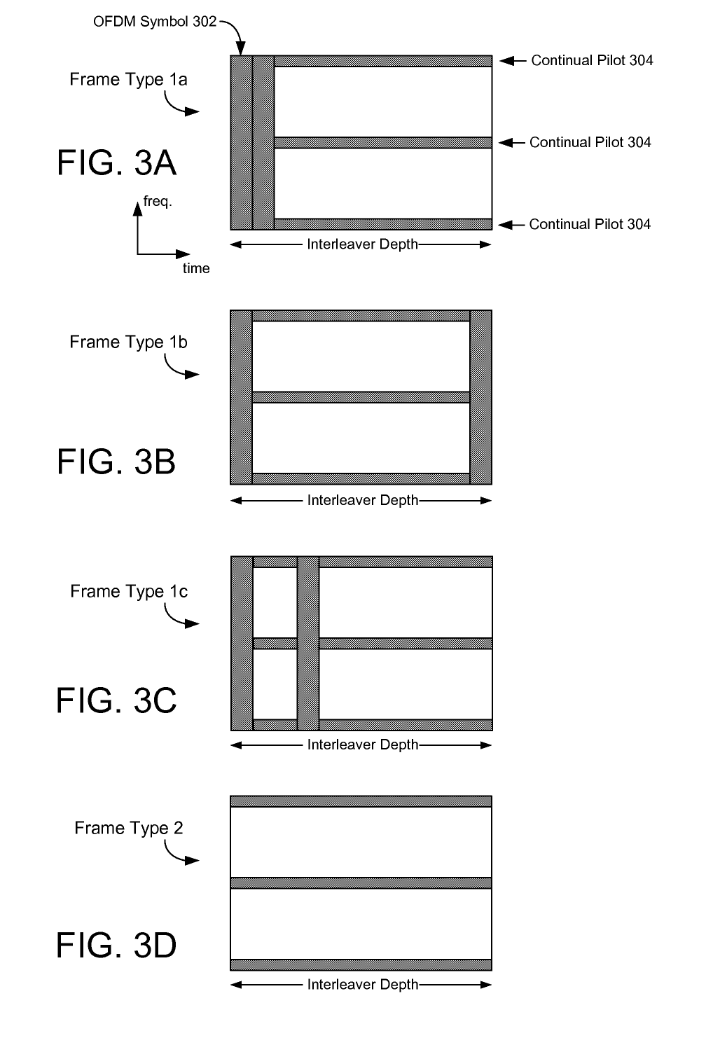

FIGS. 3A-3D show examples of types of frames (or subframes), or portions thereof, used for transmissions between a CLT 162 and CNUs 140 on a cable plant 150 in accordance with some embodiments. For example, the (sub)frames and corresponding pilot structures of FIGS. 3A-3D may be used for non-continuous transmissions (e.g., transmissions in a burst mode) between a CLT 162 and CNUs 140, such as FDD and TDD upstream transmissions and/or TDD downstream transmissions. (FDD stands for frequency-division duplexing; TDD stands for time-division duplexing.) In some embodiments, the (sub)frames and corresponding pilot structures of FIGS. 3A-3D are used for TDD downstream transmissions but not for TDD upstream transmissions. In some embodiments, FIGS. 3A-3D are examples of portions of frames corresponding to respective groups of contiguous subcarriers (e.g., which are directed to respective CNUs 140 for downstream transmissions). In some embodiments, FIGS. 3A-3D are examples of resource blocks (e.g., which are used for upstream transmissions from respective CNUs 140 to the CLT 162).

In FIGS. 3A-3D the x-axis corresponds to time (and thus to OFDM symbols 302) and the y-axis corresponds to frequency (and thus to subcarriers). The frames of FIGS. 3A-3D include OFDM symbols 302 that include pilot symbols on specified subcarriers. The pilot symbols are known modulation symbols (e.g., QPSK constellation points). In some embodiments, the (sub)frames of FIGS. 3A-3D have durations equal to the depth over which time interleaving of symbols is performed. The shaded rows correspond to subcarriers that carry a pilot symbol in each OFDM symbol 302 of the frame. Such pilot symbols are referred to as continual pilot symbols 304 (or continual pilots 304 for short). The shaded columns correspond to OFDM symbols 302 that include additional pilot symbols beyond the continual pilot symbols. These additional pilot symbols, which are referred to as regular pilot symbols (or regular pilots for short), may be placed on all or a portion of the subcarriers in an OFDM symbol. The regular pilot symbols are not continual, since they are not present in each OFDM symbol 302, and therefore may also be referred to as non-continual pilot symbols.

In some embodiments, (sub)frames include regular pilots on two of their OFDM symbols 302. For example, frame types 1a, 1b, and 1c (FIGS. 3A, 3B, and 3C) include regular pilots in two OFDM symbols 302 and continual pilot symbols in all other OFDM symbols 302. For frame type 1a, the two OFDM symbols 302 with regular pilot symbols are the first two OFDM symbols 302 of the (sub)frame. For frame type 1b, the two OFDM symbols 302 with regular pilot symbols are the first and last OFDM symbols 302 of the (sub)frame. For frame type 1c, the two OFDM symbols 302 with regular pilot symbols are the first OFDM symbol 302 and a subsequent OFDM symbol 302 (e.g., the fourth OFDM symbol 302) that is not the second or last OFDM symbol 302. Frame type 1c offers better immunity to burst noise than frame types 1a and 1b, because regular pilot symbols are in non-adjacent OFDM symbols 302. (In type-1b frames, pilot symbols in the last OFDM symbol 302 of a frame are adjacent to pilot symbols in the first OFDM symbol 302 of the next frame.) Alternatively, or in addition, type 2 (sub)frames that include continual pilot symbols 304 but do not include regular pilot symbols may be used. In some embodiments, regular and/or continual pilot symbols are symmetric about a center subcarrier (e.g., the DC subcarrier): if a pilot symbol is placed on a subcarrier f, a pilot symbol is also placed on a sub-carrier −f. (In other embodiments, however, only a portion of the pilot symbols are symmetric. The use of non-symmetric pilot symbols reduces pilot symbol overhead.)

The density of pilot symbols in the frame types 1a, 1b, 1c, and 2 is configurable. For example, overhead due to regular pilot symbols may be decreased by increasing the lengths of (sub)frames of types 1a, 1b, and 1c, or by using more (sub)frames of type 2 and fewer (sub)frames of type 1a, 1b, or 1c. Delay associated with the (sub)frames may be reduced by decreasing (sub)frame length, but at the cost of increasing overhead for (sub)frames of types 1a, 1b, and 1c. Pilot symbol density may be configured in accordance with channel conditions, with increased pilot symbol density for poor (e.g., low-SNR) channel conditions and vice-versa.

The regular pilot symbols may be used to make a channel estimate by determining the channel impulse response. The receiving device may use the channel impulse response to compensate for signal impairments. Alternatively, the receiving device may provide the channel impulse response to the transmitting device, which may pre-compensate for it. The continual pilot symbols 304 may be used to track and/or update the channel impulse response. For example, the continual pilot symbols 304 may be used to track and/or update carrier-frequency offset (e.g., in the downstream), sampling frequency offset, and carrier phase noise. Furthermore, use of only type-2 (sub)frames may be sufficient for upstream transmissions. For example, a CNU may pre-compensate for the channel and the CLT estimates a single phase and amplitude using the continual pilot symbols.

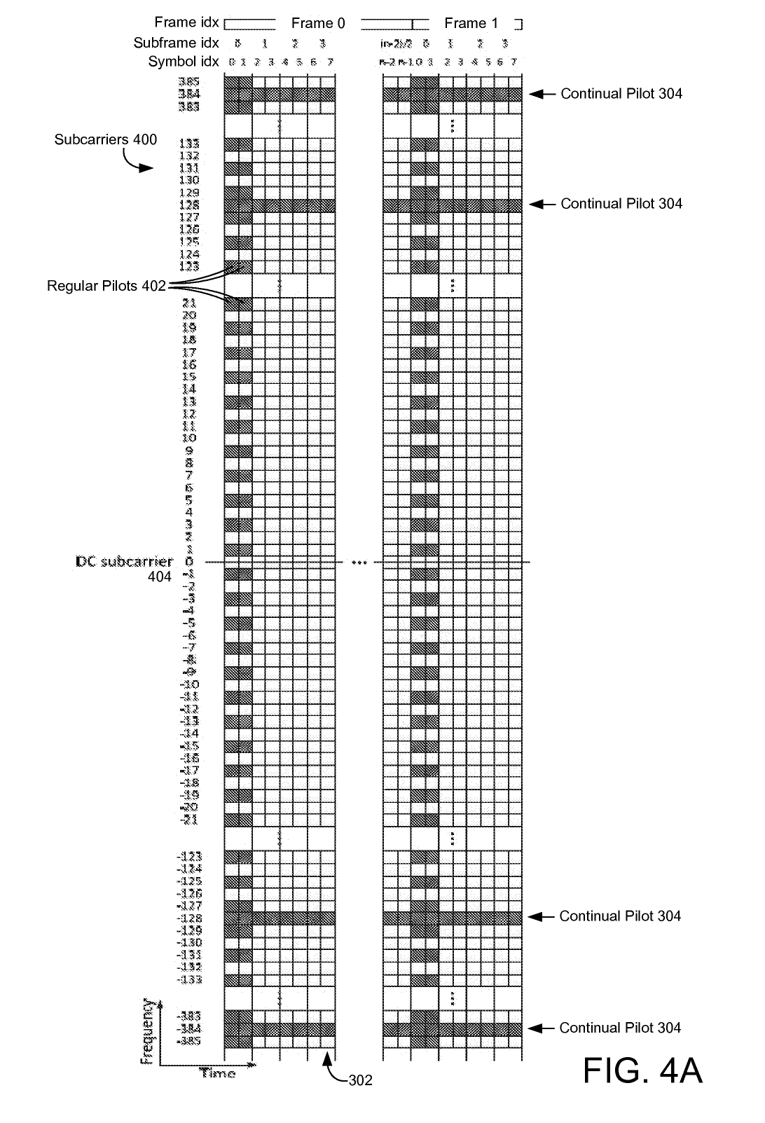

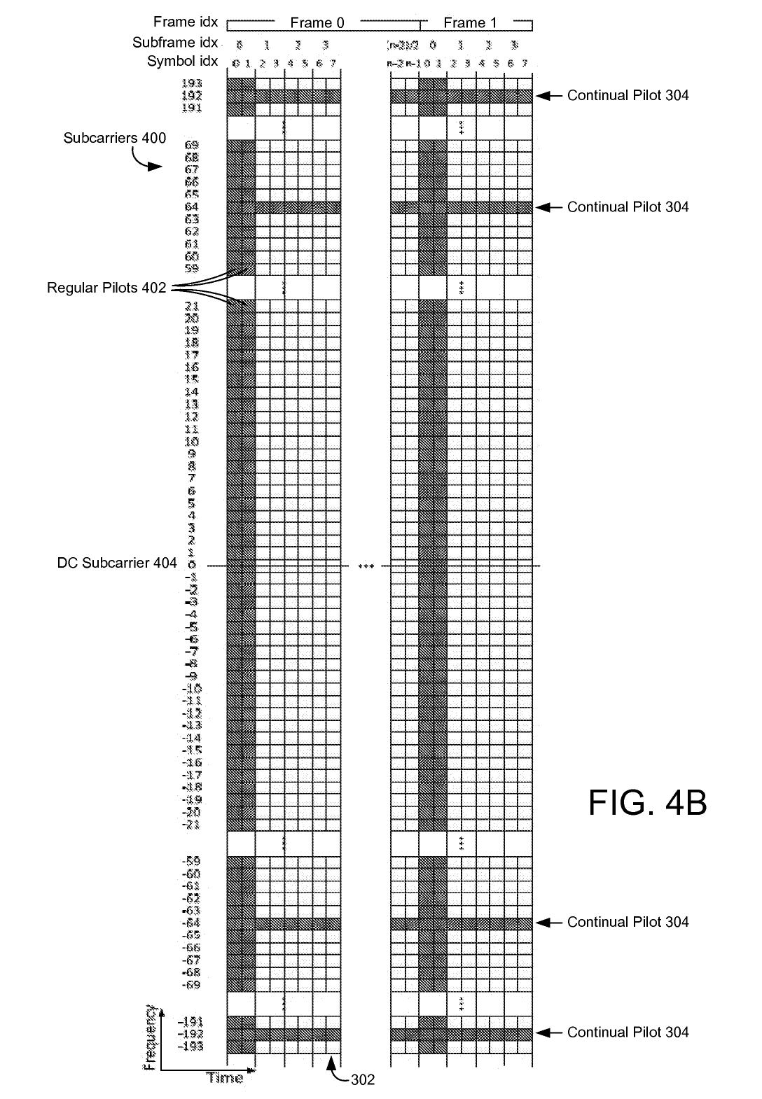

FIGS. 4A and 4B illustrate examples of type-1a frames in accordance with some embodiments. (In these figures and subsequent figures, the placing of the pilot symbols is indicated by boxes with fill patterns.) The OFDM symbols 302 are indexed by a symbol index (“symbol idx”) and the subcarriers 400 are indexed by a subcarrier index (e.g., the numbers ranging from 0 to +/−385 in FIG. 4A). Successive pairs of OFDM symbols 302 compose respective subframes, which are indexed by a subframe index (“subframe idx”). For example, within a given frame, OFDM symbols 0 and 1 compose subframe 0, OFDM symbols 2 and 3 compose subframe 1, and OFDM symbols n−2 and n−1 compose subframe (n−2)/2 (=n/2−1). A specified number n of OFDM symbols 302 compose a frame. Frames are indexed by a frame index (“frame idx”). FIGS. 4A and 4B show only a snapshot (i.e., a portion) of the available subcarriers. For example, there may be 4096, 8192, or 16,384 subcarriers.

In FIG. 4A, pilot symbols are placed symmetrically (with mirror symmetry) about the DC subcarrier 404 (i.e., the subcarrier with index 0). Subframe 0 of a frame (e.g., of each frame) includes regular pilot symbols 402 on every other subcarrier 400 (i.e., on alternating subcarriers 400): regular pilot symbols 402 are placed on subcarriers +/−1, +/−3, etc. (This spacing may be configurable.) For subframes 0 to n/2−1 of a frame (e.g., of each frame), continual pilot symbols 304 are placed on specified subcarriers 400 in a grid, such that the continual pilot symbols 304 are placed on the same subcarriers 400 in each OFDM symbol 302. The subcarriers 400 on which the continual pilot symbols 304 are placed are symmetric (with mirror symmetry) about the DC subcarrier 404. The subcarriers 400 for the continual pilot symbols 304 (i.e., subcarriers +/−128, +/−384, etc.) have a spacing of 256 subcarriers 400. (This spacing may be configurable.) In some embodiments, the subcarrier spacing (i.e., the spacing between successive subcarriers 400) in FIG. 4A is 25 kHz and the continual pilot symbol spacing of 256 results in a separation of 6400 kHz between continual pilot symbols 304. In some embodiments of FIG. 4A, each frame includes 64 or 128 OFDM symbols 302 (i.e., n=64 or 128). In one example, a frame includes 128 OFDM symbols 302, resulting in a regular pilot symbol overhead of 1/128, a continual pilot symbol overhead of 1/256, and a combined pilot symbol overhead of 3/256=1.17%.

In the example of FIG. 4A, the continual pilot symbols 304 in subframe 0 (e.g., as placed on subcarriers +/−128 and +/−384) fall between regular pilot symbols 402. The continual pilot symbols 304 in subframe 0 may be used to track and/or update a previous channel estimate made for a previous frame and to receive/detect data in subframe 0 accordingly, since the channel estimate made using subframe 0 of a particular frame is not available when detecting data symbols for subframe 0 of that frame.

In FIG. 4B, pilot symbols are again placed symmetrically (with mirror symmetry) about the DC subcarrier 404. Subframe 0 of a frame (e.g., of each frame) includes regular pilot symbols 402 on every subcarrier 400. (This spacing may be configurable.) For all subframes, continual pilot symbols 304 are placed on specified subcarriers 400 in a grid, such that the continual pilot symbols 304 are placed on the same subcarriers 400 in each OFDM symbol 302. The subcarriers 400 on which the continual pilot symbols 304 are placed are symmetric (with mirror symmetry) about the DC subcarrier 404. The subcarriers 400 on which the continual pilot symbols 304 are placed (i.e., subcarriers +/−64, +/−192, etc.) have a spacing of 128 subcarriers 400. (This spacing may be configurable.) In some embodiments, the subcarrier spacing in FIG. 4B is 50 kHz and the continual pilot symbol spacing of 128 results in a separation of 6400 kHz between continual pilot symbols 304. In some embodiments of FIG. 4A, each frame includes 128 or 256 OFDM symbols 302 (i.e., n=128 or 256). In one example, a frame includes 128 OFDM symbols 302, resulting in a regular pilot symbol overhead of 1/128, a continual pilot symbol overhead of 1/128, and a combined pilot symbol overhead of 1/64=1.56%.

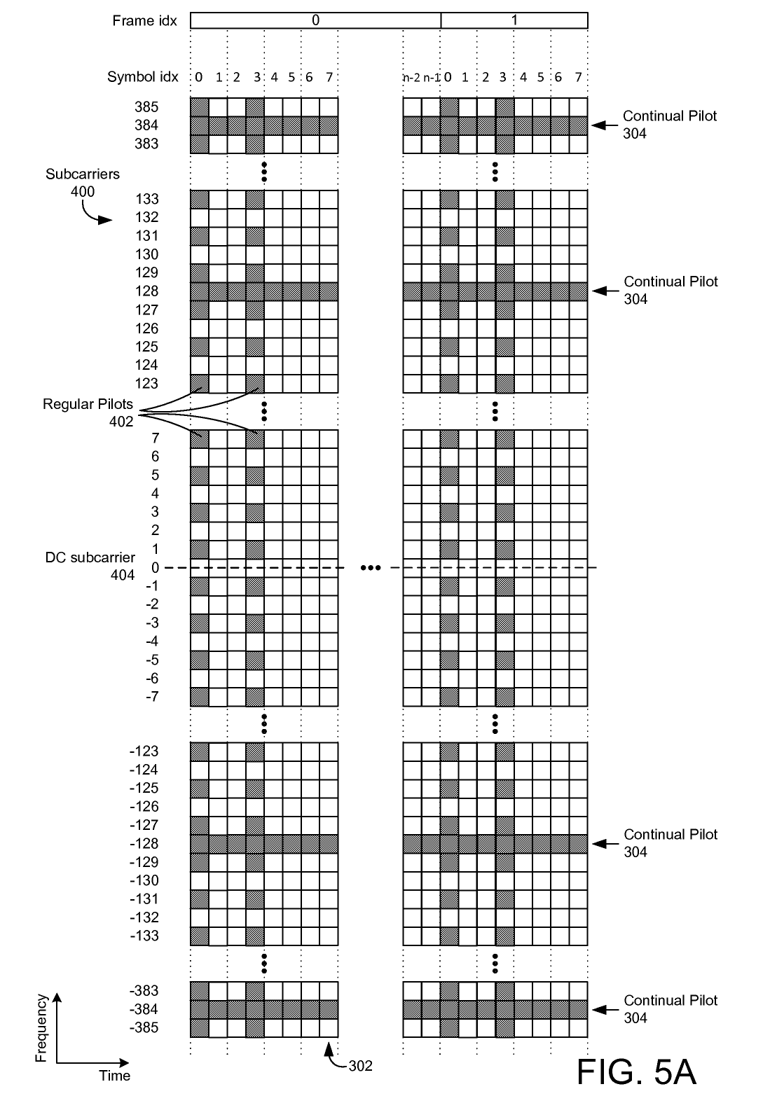

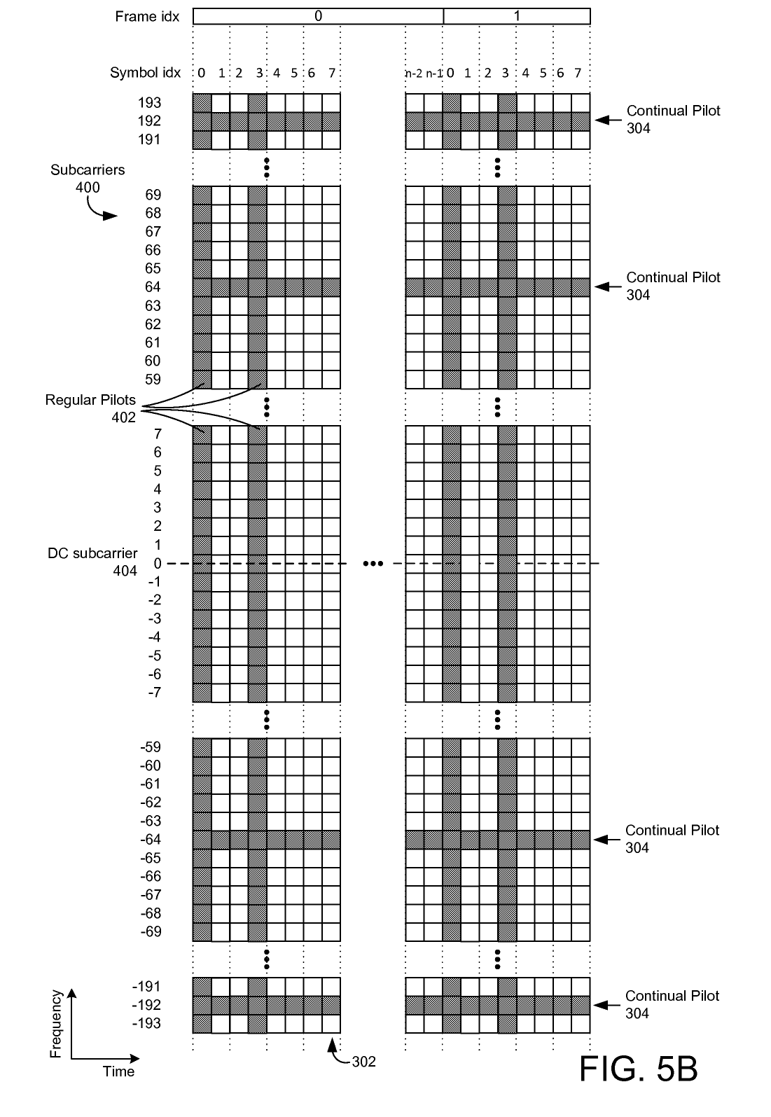

FIGS. 5A and 5B illustrate examples of type-1c frames in accordance with some embodiments. The frames of FIGS. 5A and 5B correspond to the frames of FIGS. 4A and 4B, except that the regular pilot symbols 402 are placed in the first and fourth OFDM symbols 302 of each frame instead of in the first and second OFDM symbols 302 of each frame. The continual pilot symbols 304 in the frames of FIGS. 5A and 5B are used to track and/or update a previous channel estimate until a new channel estimate is determined using the regular pilot symbols 402.

Examples of type-1b frames may be generated by analogy to FIGS. 4A-4B and 5A-5B.

In some embodiments, frames may be constructed from resource blocks (also referred to as physical resource blocks). A resource block is the smallest unit of combined time and frequency resources that can be allocated to a CNU 140. In some embodiments, resource blocks are allocated in their entirety to respective CNUs 140, such that resource blocks are not shared among CNUs 140. Each resource block includes a specified number of subcarriers 400 and has a duration equal to the length of a specified number of OFDM symbols 302. For each OFDM symbol 302, each subcarrier 400 in a resource block may carry a distinct modulation symbol (e.g., a QAM symbol). A particular subcarrier 400 within a particular OFDM symbol 302 may be referred to as a resource element; a resource block is thus a matrix of resource elements. The size of this matrix (i.e., the number of subcarriers 400 and OFDM symbols 302 per resource block) may vary from cable plant 150 to cable plant 150 and may be configurable. In some embodiments, all CNUs 140 have the same number of OFDM symbols 302 per resource block. Multiple resource blocks in a frame may be assigned to a particular CNU 140. Also, different resource blocks (or groups of resource blocks) in a frame may be assigned to different CNUs 140 (e.g., using OFDMA).

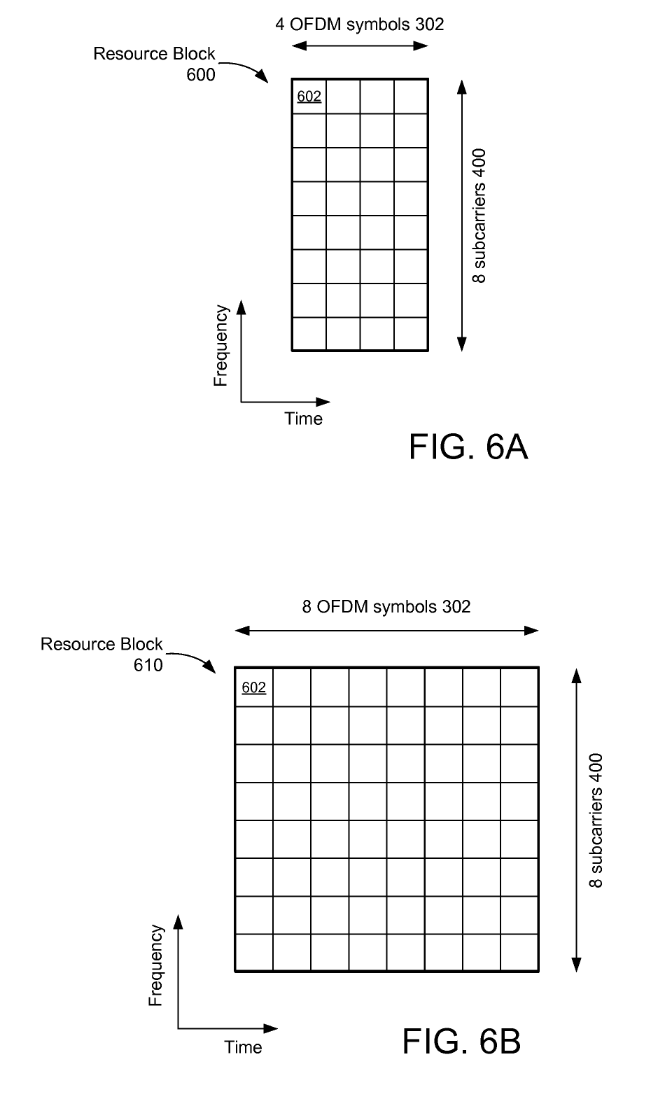

FIGS. 6A and 6B show examples of resource blocks 600 and 610, respectively, in accordance with some embodiments. In these examples, each resource block includes eight subcarriers 400. The resource block 600 has a length of four OFDM symbols 302, while the resource block 610 has a length of eight OFDM symbols. The resource block 600 is therefore a 4×8 matrix of resource elements 602, while the resource block 610 is an 8×8 matrix of resource elements 602. Other examples of resource block lengths include, but are not limited to, 16 or 32 OFDM symbols 302. The resource block length may be configurable (e.g., on a cable plant by cable plant basis). In some embodiments, resource blocks have a length of one or two OFDM symbols 302 (e.g., if time interleaving is not performed). In some embodiments, the length of the resource block corresponds to the depth of the time interleaver.

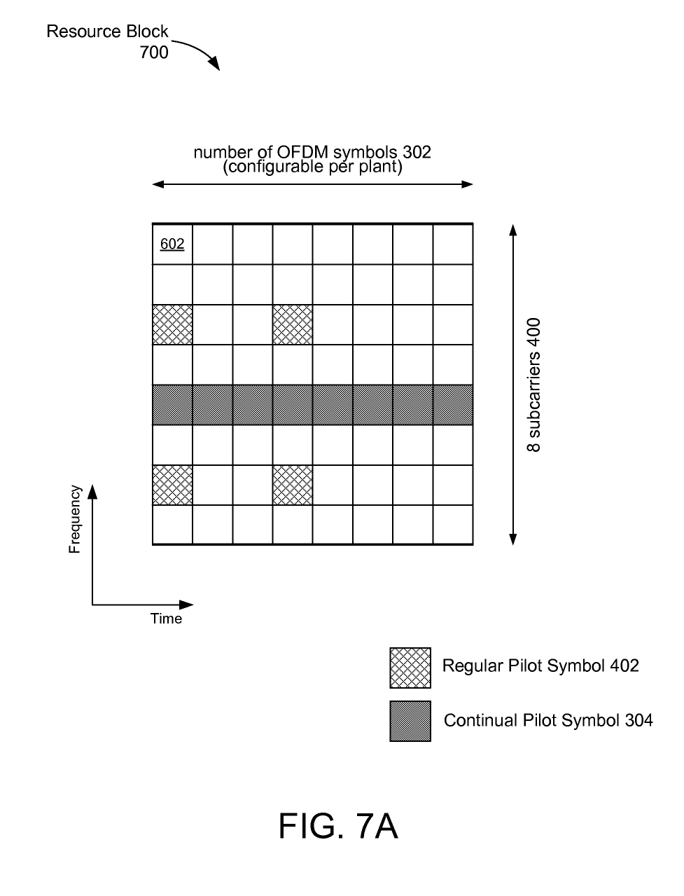

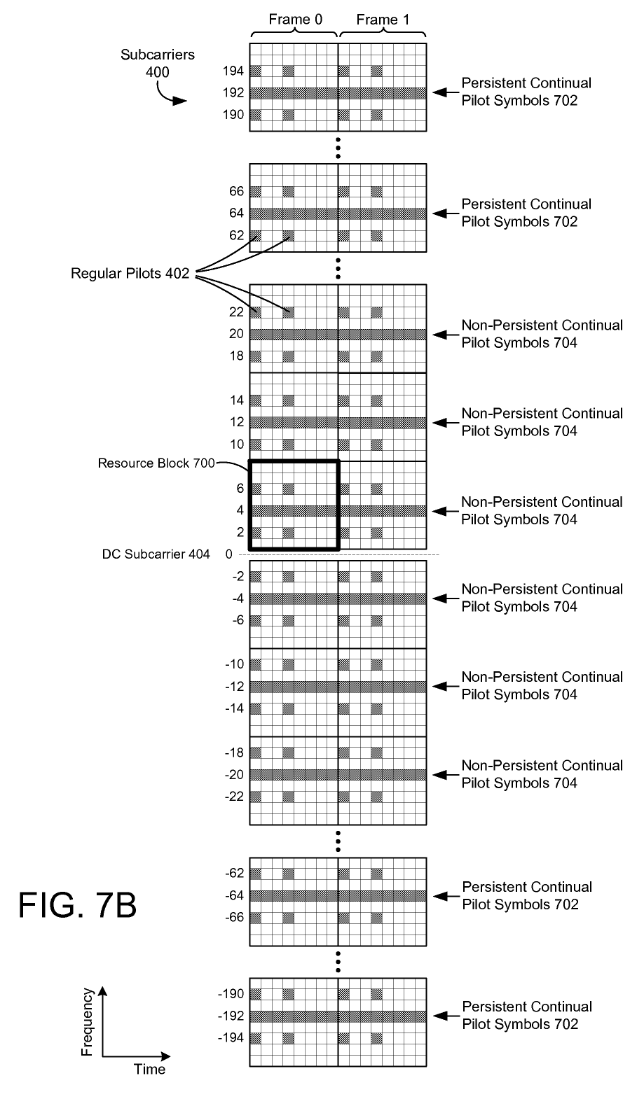

FIG. 7A shows an example of pilot symbol placement in a resource block 700 (e.g., the resource block 610, FIG. 6B) in accordance with some embodiments. Continual pilot symbols 304 are placed on a single specified subcarrier 400 (or alternatively, two or more specified subcarriers 400) in the resource block 700. Regular pilot symbols 402 are placed on specified subcarriers 400 in the first and fourth OFDM symbols 302 (or more generally, in two specified OFDM symbols 302). The resource block 700 thus may be used to create a type-1c (sub)frame. In some embodiments, regular pilot symbols 402 may instead be placed on specified subcarriers 400 in the first and second OFDM symbols 302 of the resource block or in the first and last OFDM symbols 302 of the resource block. The resulting resource blocks may be used to create type-1a or type-1b (sub)frames, respectively. In other examples, the regular pilot symbols 402 are omitted, and the resource block is used to create a type-2 (sub)frame. Resource blocks (e.g., the resource block 700) may be mirrored about the DC subcarrier 404 when constructing frames, to ensure that pilot symbols are symmetric with respect to the DC subcarrier. In some embodiments, the pilot symbol for each resource element 602 that carries a pilot symbol is a QPSK constellation point derived from a pseudo-random sequence.

FIG. 7B shows frames (or subframes) generated using resource blocks 700 (FIG. 7A) in accordance with some embodiments. Successive sets of eight contiguous subcarriers 400 within each frame are examples of the resource block 700. The resource blocks 700 are mirrored about the DC subcarrier 404, which is left empty. The spacing of the regular pilot symbols 402 in the resource block 700 results in evenly spaced regular pilot symbols 402 in the frames of FIG. 7B. In some embodiments, the frames of FIG. 7B are used for upstream transmissions from CNUs 140 to a CLT 162.

An allocation granted to a specific CNU 140 may cover multiple resource blocks 700, such that the CNU 140 may use the subcarriers 400 in the multiple resource blocks 700 to transmit. A marker may indicate the beginning of the grant and may contain information about the grant. In some embodiments, the marker is placed at the beginning of a resource block 700 and thus does not collide with pilot symbols.

In some embodiments, the continual pilot symbols 304 are divided into persistent continual pilot symbols 702 and non-persistent continual pilot symbols 704. Both the persistent continual pilot symbols 702 and non-persistent continual pilot symbols 704 are evenly spaced around the DC subcarrier 404. Persistent continual pilot symbols 702 are included regardless of whether or not the allocation grant covers multiple resource blocks 700. Non-persistent continual pilot symbols 704 may be omitted, however, if the grant covers multiple resource blocks 700. In some embodiments, at least one continual pilot symbol 304 is included within the multiple resource blocks 700 allocated to a particular CNU 140. The included continual pilot symbol(s) 304 may be chosen in accordance with a predefined rule (e.g., as implemented in the coax PHY 224, FIG. 2). In some embodiments, the persistent continual pilot symbols 702 have a predefined spacing (e.g., a spacing of 128 as shown in FIG. 7B).

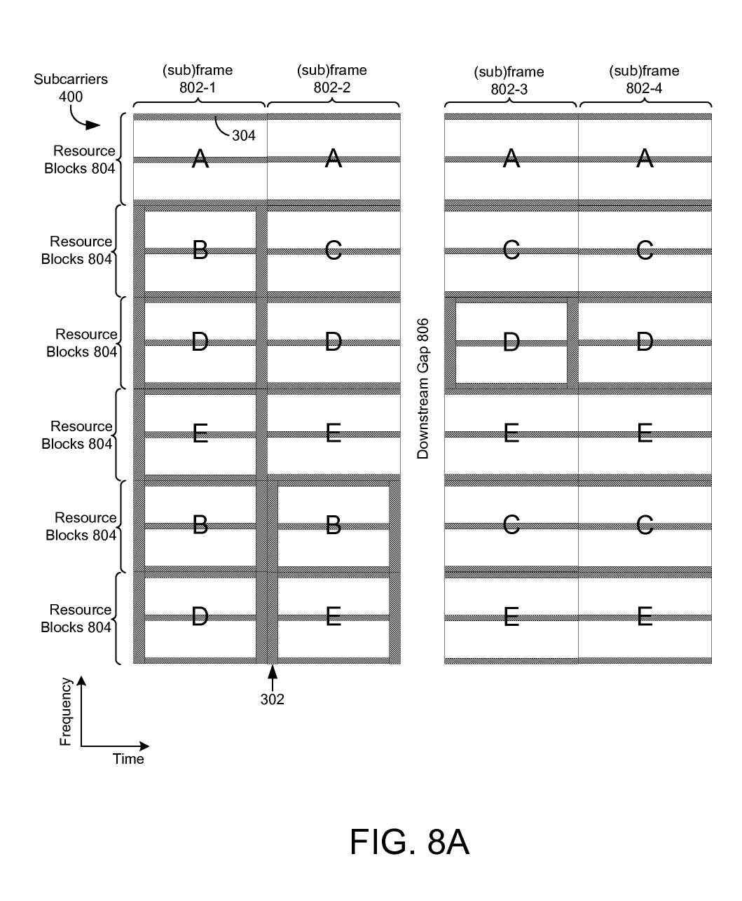

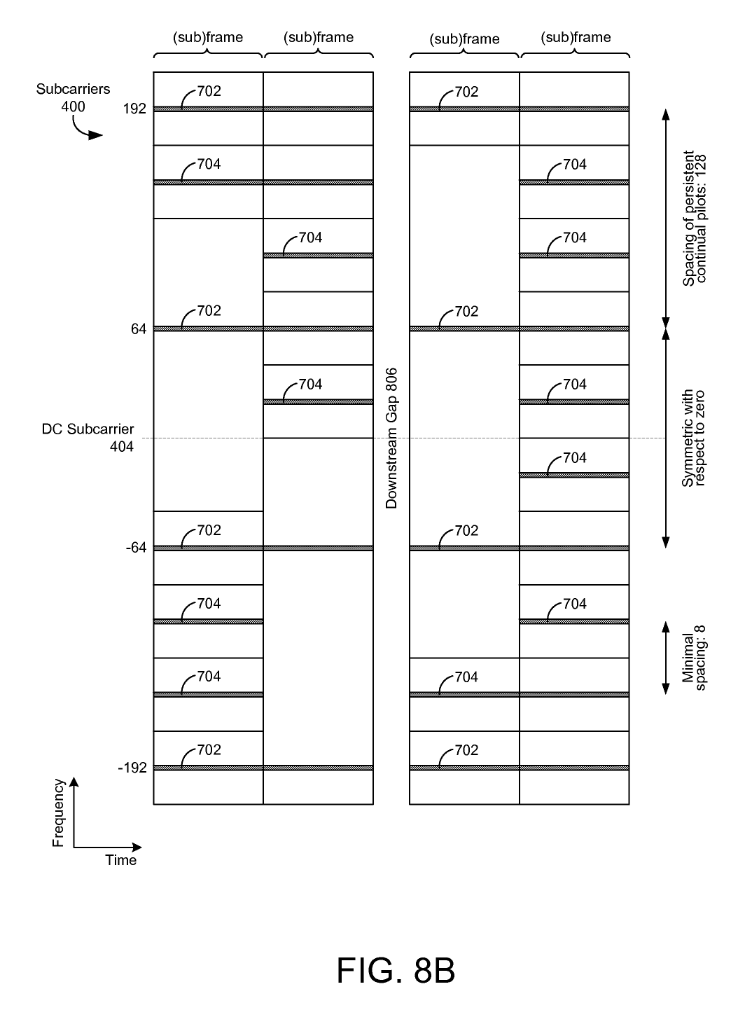

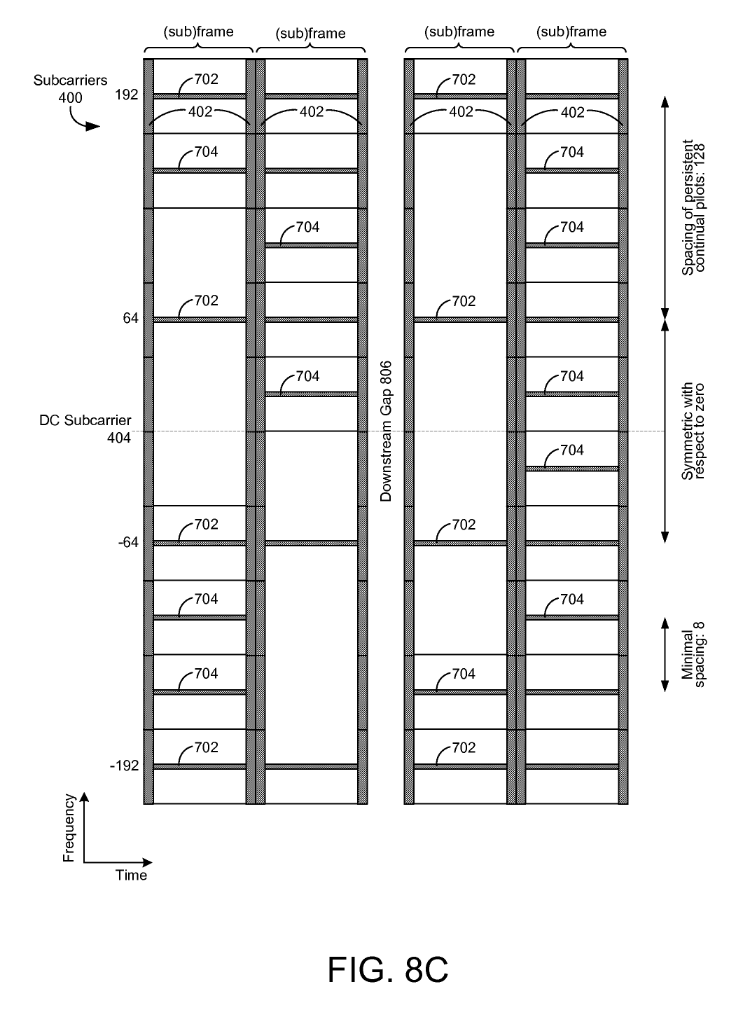

FIG. 8A illustrates the use of multiple frame types within OFDMA (sub)frames 802-1 through 802-4 in accordance with some embodiments. Resource blocks 804 in the (sub)frames 802-1 through 802-4 are allocated to five different CNUs 140, labeled A through E. The (sub)frames 802-1 through 802-4 are used for upstream transmissions from the CNUs A-E to a CLT 162. The first two (sub)frames 802-1 and 802-2 are separated from the second two (sub)frames 802-3 and 802-4 by a downstream gap 806 (not to scale) during which the CLT 162 may transmit to the CNUs A-E. In the example of FIG. 8A, all of the transmissions from CNUs A and C use frame type 2 (FIG. 3D). For example, the CNUs A and C perform sufficient pre-compensation to allow the CLT 162 to receive their signals properly without regular pilot symbols 402 and thus without generating a full channel estimate. The CNU B uses frame type-1b (FIG. 3B) (or alternately type-1a or type-1c, FIGS. 3A and 3C) for each of the (sub)frames 802-1 through 802-4, allowing the CLT 162 to generate a full channel estimate for CNU B in response to each of the (sub)frames 802-1 through 802-4.

Where the CNU D is assigned the same subcarriers 400 in successive ones of the (sub)frames 802-1 through 802-4, the CNU D uses frame type 1b (FIG. 3B) (or alternately type 1a or type 1c, FIGS. 3A and 3C) for the first frame and frame type 2 (FIG. 3D) for the second frame. The CLT 162 thus generates a full channel estimate for CNU D using the regular pilot symbols 402 that the CNU D transmits in the frame 802-1. The CLT 162 tracks/updates that estimate using the continual pilot symbols 304 that the CNU D transmits in the frame 802-2. The CLT 162 is not able to track the channel estimate for CNU D across the downstream gap 806, however. The CNU D thus uses frame type 1b (or alternately type 1a or type 1c) again for the first frame 802-3 after the downstream gap, followed by frame type 2 for the next frame 802-4.

Where the CNU E is assigned the same subcarriers 400 in successive frames, the CNU E uses frame type 1b (FIG. 3B) (or alternately type 1a or type 1c, FIGS. 3A and 3C) for the first frame and frame type 2 (FIG. 3D) for subsequent frames. The CLT 162 thus generates a full channel estimate using the regular pilot symbols 402 of the first frame (e.g., frame 802-1 for the fourth set of resource blocks 804 and frame 802-2 for the sixth set of resource blocks 804) and tracks/updates that estimate using the continual pilot symbols 304 of the subsequent frames (e.g., frames 802-2 through 802-4 for the fourth set of resource blocks 804 and frames 802-3 through 802-4 for the sixth set of resource blocks 804). The CLT 162 is able to track the channel estimate for CNU E across the downstream gap 806. The CNU E therefore continues to uses frame type 2 after the downstream gap 806. The maximum tracking time for the CNU E is thus longer than for the CNU D.

In some embodiments, the CLT 162 stores previous channel estimates (e.g., channel impulse responses) for the CNUs A-E, in case respective ones of the CNUs A-E are subsequently scheduled to use the same frequencies (e.g., the same subcarriers 400). The CLT 162 may discard previous channel estimates, however, as new channel estimates are generated, to save memory.

In some embodiments, the CLT 162 (e.g., the coax PHY 212, FIG. 2) performs auto-detection of frame types. This auto-detection is based, for example, on the fact that possible pilot symbol positions are restricted to certain predefined subcarriers 400 and that the power of pilot symbols is boosted. Alternatively, frame types are determined based on markers transmitted upstream from the CNUs 140. For example, markers may specify the locations of pilot symbols and the number of resource blocks allocated to a particular CNU 140. In some embodiments, markers allow the CLT 162 to determine whether respective pilots are coming from the same CNU 140 as in a previous frame. By determining that a subsequent allocation is from the same CNU 140 (e.g., from the same user) as a previous allocation, the CLT 162 is able to re-use the previous channel estimate.

The MAC 218 (FIG. 2) in each CNU 140 is aware of the frame type(s) used by the corresponding coax PHY 224 and of the OFDM symbol duration. In some embodiments, this information is derived from the time between grants, which corresponds to the allocated bandwidth and thus to the frame type(s). The MAC 218 may not be aware of the frequencies (e.g., the subcarriers 400) used by the coax PHY 224, however. In some embodiments, the MAC 218 determines if an allocation is for the same subcarriers 400 as a previous allocation based on the time between grants and determines a corresponding effective rate.

In some embodiments, frame-type configurations are exchanged between respective PHYs and MACs (e.g., the coax PHY 212 and MAC 206, and/or the coax PHY 224 and/or MAC 218, FIG. 2) using management data input/output (MDIO).

FIG. 8B shows an example of a mode of operation in which transmissions use continual pilot symbols 304 but not regular pilot symbols 402, in accordance with frame type 2 (FIG. 3D). The continual pilot symbols 304 include persistent continual pilot symbols 702 on subcarriers +/−64 and +/−192 and non-persistent continual pilot symbols 704 on other subcarriers 400. The persistent continual pilot symbols 702 are present in every (sub)frame; the non-persistent continual pilot symbols 704 are not. In some embodiments, the pilot symbols 702 and 704 of FIG. 8B are used after the CLT 162 generates full channel estimates for the CNUs 140 on its cable plant 150 and feeds the channel estimates back to the respective CNUs 140, which then use their respective channel estimates to perform pre-equalization.

In some embodiments, if multiple subcarriers 400 with continual pilot symbols 304 fall within the same allocation, only some (e.g., one) of those subcarriers are used to transmit continual pilot symbols 304 for the allocation, thus reducing overhead. For example, if an allocation includes a subcarrier 400 with persistent continual pilot symbols 702, only the persistent continual pilot symbols 702 on that subcarrier are transmitted; no other continual pilot symbols (e.g., no non-persistent continual pilot symbols 704) are transmitted for the allocation. If there is no allocation to any CNU 140, some continual pilot symbols 304 (e.g., all non-persistent continual pilot symbols 704) may not be transmitted.

FIG. 8C shows an example of a mode of operation in which transmissions use continual pilot symbols 304 as well as regular pilot symbols 402 in accordance with type-1b frames (FIG. 3B). (Similar modes of operation may be implemented in accordance with type-1a frames or type-1c frames, FIGS. 3A and 3C.) The continual pilot symbols 304, which include persistent continual pilot symbols 702 and non-persistent continual pilot symbols 704, are placed as described for FIG. 8B. The density of the regular pilot symbols 402 is configurable. For example, regular pilot symbols 402 may be placed on every subcarrier 400, every other subcarrier 400, every fourth subcarrier 400, or every eighth subcarrier 400.

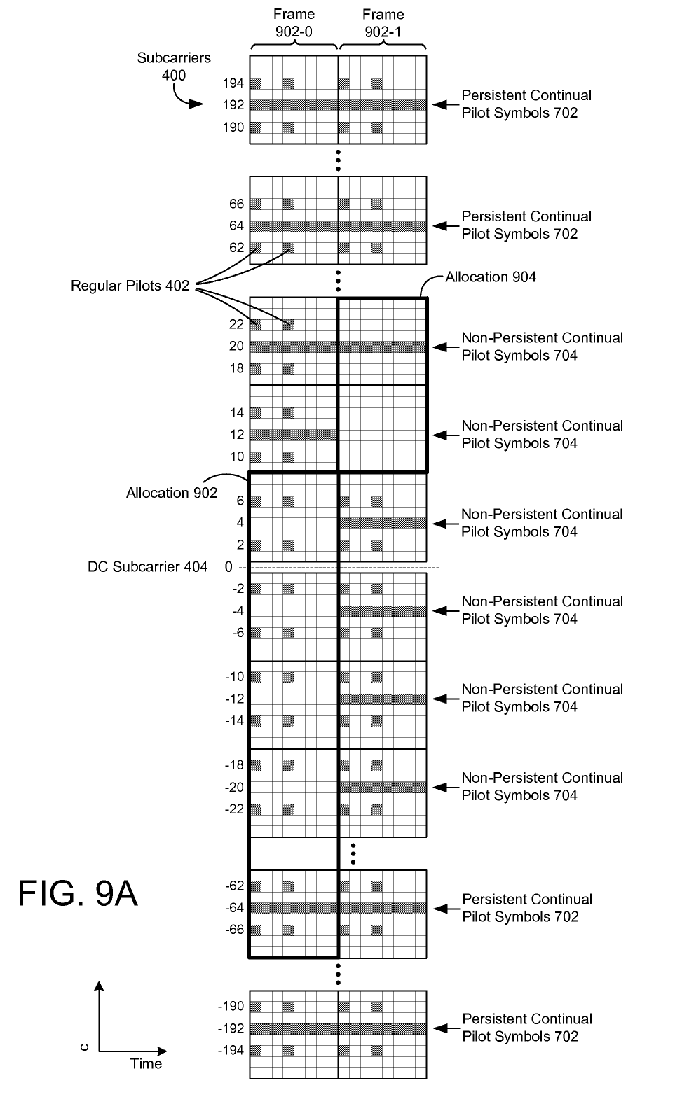

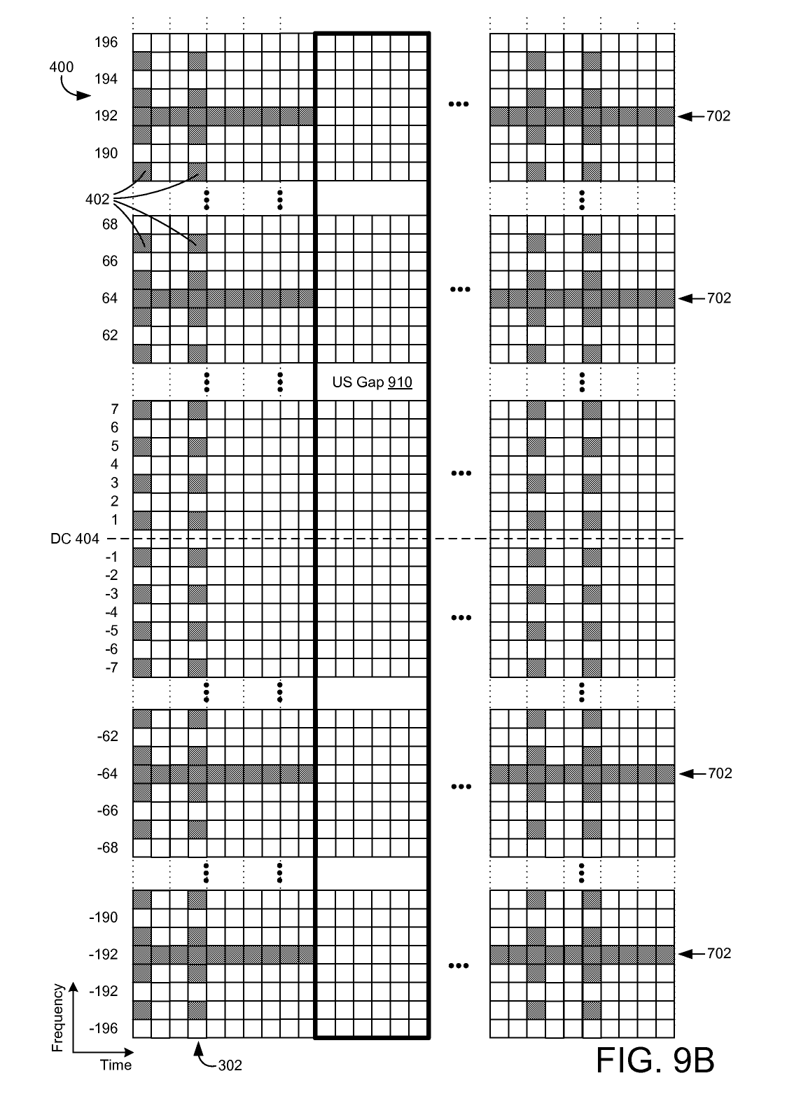

FIG. 9A shows an example of a mode of operation in which transmissions use continual pilot symbols 304 as well as regular pilot symbols 402 in accordance with type-1c frames (FIG. 3C). Allocations 902 and 904 are in separate frames 902-0 and 902-1 and extend across multiple resource blocks. The allocation 902 includes persistent continual pilot symbols 702 on subcarrier −64. Accordingly, non-persistent continual pilot symbols 704 (e.g., which would otherwise be on every eighth subcarrier) are omitted from the allocation 902, because persistent continual pilot symbols 702 are present. The allocation 904 does not include persistent continual pilot symbols 702. Accordingly, only non-persistent continual pilot symbols 704 on a single subcarrier 400 are included in the allocation 904 (e.g., as chosen in accordance with a predefined rule).

Regular pilot symbols 402 are omitted from the allocation 904 in accordance with some embodiments. For example, pre-equalization performed by the CNU 140 corresponding to the allocation 904 may be sufficient to obviate use of regular pilot symbols 402. The decision as to whether to include regular pilot symbols 402 may be made in common for all CNUs 140 in a cable plant 150 or may be specific to particular CNUs 140.

A pilot pattern used for downstream TDD transmissions may include regular pilot symbols 402 (e.g., in accordance with frame types 1a, 1b, or 1c, FIGS. 3A-3C) and persistent continual pilot symbols 702, but not non-persistent continual pilot symbols 704, as shown in FIG. 9B in accordance with some embodiments. In one example, the persistent continual pilot symbols 702 are symmetric about the DC subcarrier 404 with a spacing of 128. In some examples, regular pilot symbols 404 are included in the first and fourth OFDM symbols 302. The first through fourth OFDM symbols 302 in the frame are used for downstream transmission; additional OFDM symbols 302 in the frame are used for upstream and/or downstream transmission. OFDM symbols 302 in the upstream (US) gap 910 are used for upstream transmission. In some embodiments, regular pilot symbols 402 are repeated within the frame after each upstream gap 910 in one mode (e.g., in a robust mode) but not in another mode (e.g., in a regular mode). In some embodiments, interleaving is independent of frame length.

In some embodiments, transmissions in at least one direction do not include continual pilot symbols 304. For example, upstream transmissions may include regular pilot symbols 402 but not continual pilot symbols 304. In FIG. 9B, the persistent continual pilot symbols 702 are omitted from the upstream gap 910 and therefore are not used for upstream transmissions. (Non-persistent continual pilot symbols 704 are not used for both upstream and downstream transmissions in FIG. 9B).

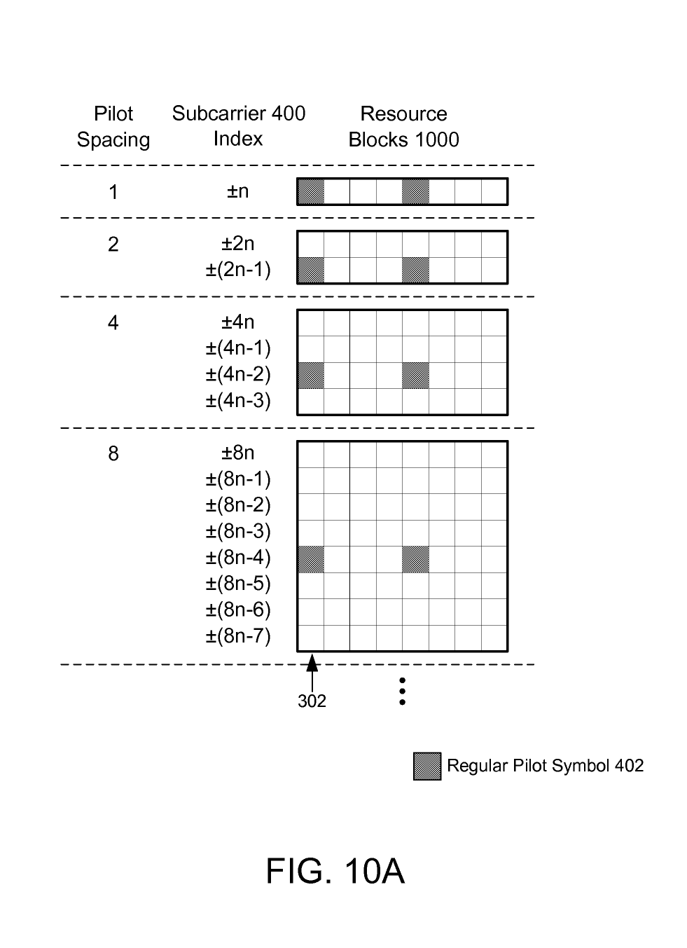

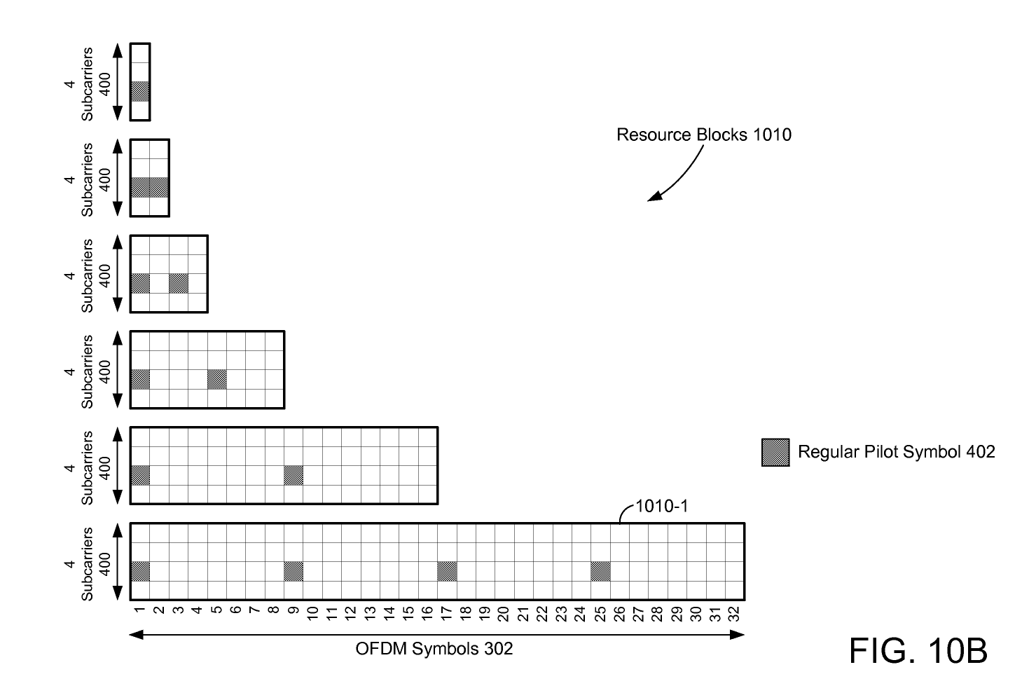

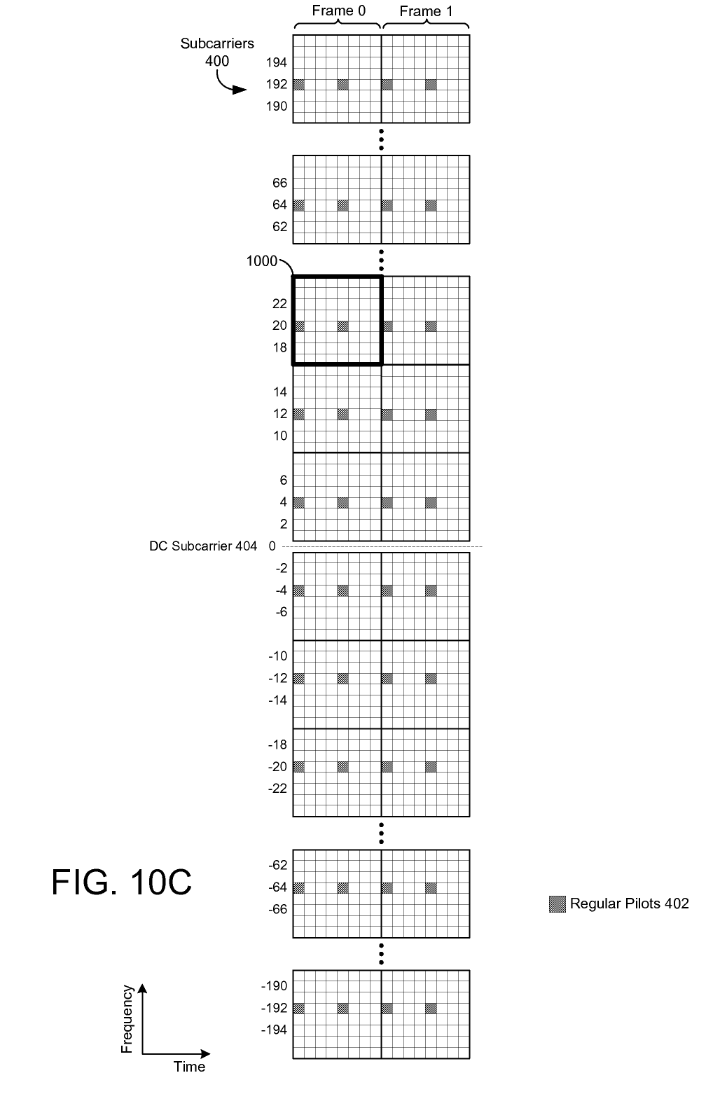

FIG. 10A shows examples of resource blocks 1000 that may be used to construct frames (or subframes) that include regular pilot symbols 402 but not continual pilot symbols 304. The resource blocks 1000 respectively include one, two, four, and eight subcarriers 400. Each resource block 1000 includes regular pilot symbols 402 in two OFDM symbols 302 on one of the subcarriers 400. The pilot spacing of (sub)frames constructed from a given type of resource block 1000 thus will equal the number of subcarriers 400 in each resource block 1000 (e.g., one, two, four, or eight). In this manner, the desired pilot density defines the number of subcarriers 400 in a resource block 1000. (Pilot density is the reciprocal of pilot spacing). Other examples of possible pilot spacing (and thus the number of subcarriers 400 per resource block 1000) include, but are not limited to, 16, 32, and 64. The subcarriers 400 in each resource block 1000 are indexed as shown in FIG. 10A, where n is an integer greater than or equal to one that indexes respective resource blocks 1000 in a (sub)frame. The number of subcarriers 400 per resource block 1000 may be chosen independently of the number of OFDM symbols 302 per resource block 1000.

In the example of FIG. 10A, the regular pilot symbols 402 are placed in the first and fifth OFDM symbols 302 of the resource block 1000, such that successive frames generated using one of the resource blocks 1000 will include regular pilot symbols 402 that are evenly spaced in time. In other examples, the regular pilot symbols 402 are placed in the first and second OFDM symbols 302 of the resource block 1000, the first and last OFDM symbols 302 of the resource block 1000, or the first OFDM symbol 302 and another OFDM symbol 302 separated from the first OFDM symbol 302 by at least one OFDM symbol 302. Resource blocks 1000 are mirrored about the DC subcarrier 404, resulting in (sub)frames in which the regular pilot symbols 402 are located on evenly spaced subcarriers 400 with mirror symmetry about the DC subcarrier 404.

FIG. 10B shows examples of resource blocks 1010 with different numbers of OFDM symbols 302 in accordance with some embodiments. These examples include resource blocks 1010 with one, two, four, eight, 16, and 32 OFDM symbols 302. The resource blocks 1010 include regular pilot symbols 402 but not continual pilot symbols 304, like the resource blocks 1000 (FIG. 10A). In some embodiments, the regular pilot symbols 402 in the resource blocks 1010 have a regular spacing in time, such that sufficiently large resource blocks 1010 include regular pilot symbols 402 in more than two OFDM symbols 302. For example, regular pilot symbols 402 may be placed in every 8th OFDM symbol 302, such that a resource block 1010-1 with 32 OFDM symbols 302 includes regular pilot symbols 402 in four evenly spaced OFDM symbols 302 on the same subcarrier 400.

In some embodiments, the number of OFDM symbols 302 in a resource block 1010 is determined by the time-interleaving depth. For example, the number of OFDM symbols 302 in a resource block 1010 equals the number of OFDM symbols 302 across which time interleaving is performed. The size of a resource block 1010 thus may be determined by the combination of time-interleaving depth and desired pilot density. The combination of a pilot density of 1/M (where M is the pilot spacing, such that every Mth subcarrier 400 carries a regular pilot symbol 402) and time-interleaving depth of N OFDM symbols 302 defines a resource block 1010 with M subcarriers 400 and N OFDM symbols 302.

FIG. 10C shows frames (or subframes) generated using resource blocks 1000 (FIG. 10A) in accordance with some embodiments. The resource blocks 1000 used to generate the frames (or subframes) of FIG. 10C each include eight subcarriers 400 and eight OFDM symbols 302. Each resource block 1000 covers subcarriers +/−Mn+1 to +/−M(n+1), where M is the pilot-symbol subcarrier spacing (e.g., M=8) and n is an integer that indexes the resource blocks 1000. The resource blocks 1000 are mirrored about the DC subcarrier 404, which is left empty. In some embodiments, the frames of FIG. 10C are used for upstream transmissions from CNUs 140 to a CLT 162.

As discussed, a grant may allocate one or more resource blocks 1000 (FIG. 10A) or 1010 (FIG. 10B) to a respective CNU 140. The CNU 140 may use the allocated resource blocks 1000 or 1010 in the grant to transmit upstream to a CLT 162. In some embodiments, the start of a grant is identified by a start marker and the end of a grant is identified by an end marker. In some embodiments, the start and end markers are detected incoherently, without prior knowledge of the channel. Once detected, the start and end markers serve as known sequences that may be used as pilot symbols. Since the start and end markers are located on subcarriers 400 at the beginning and end of the grant, using the start and end markers as pilot symbols avoids extrapolating at the edges of the grant when estimating the channel. The grant may also include regular pilot symbols 402 (e.g., in accordance with FIGS. 10A-10C).

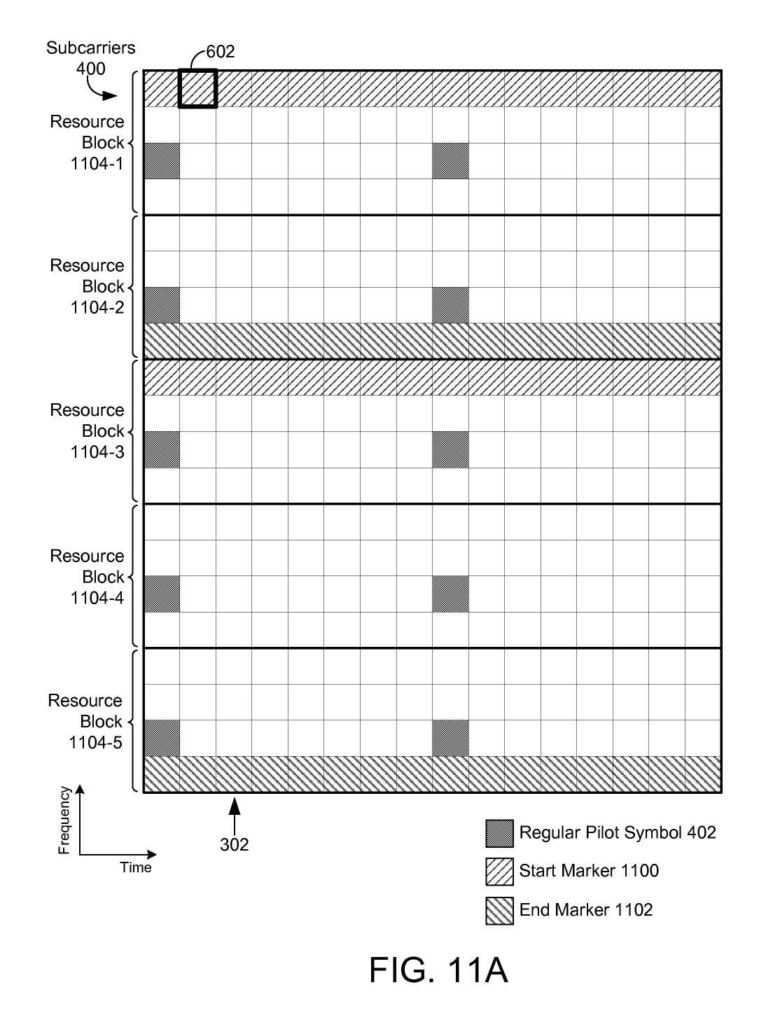

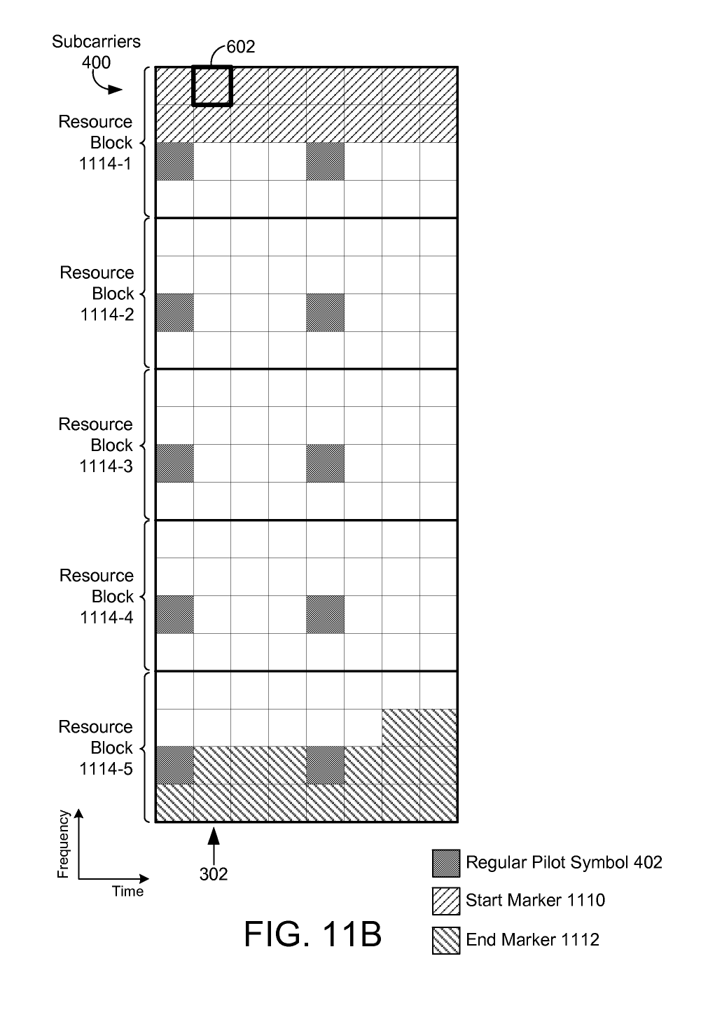

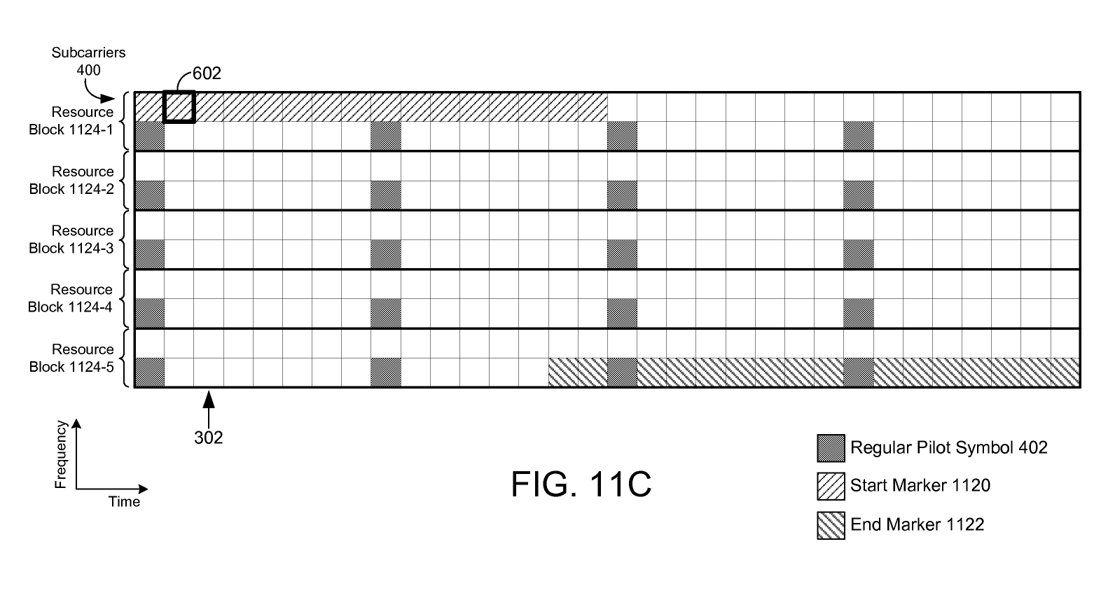

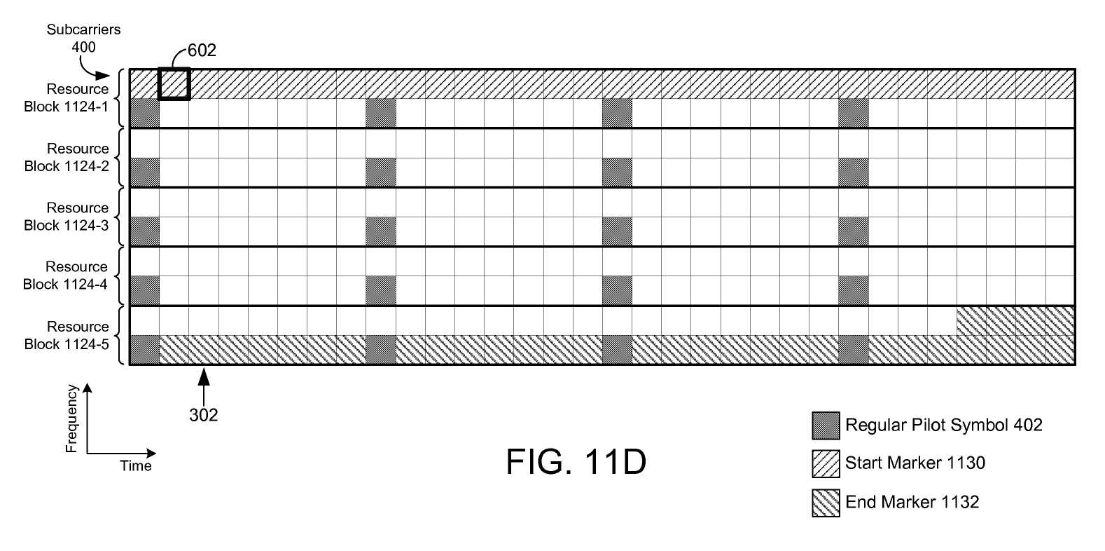

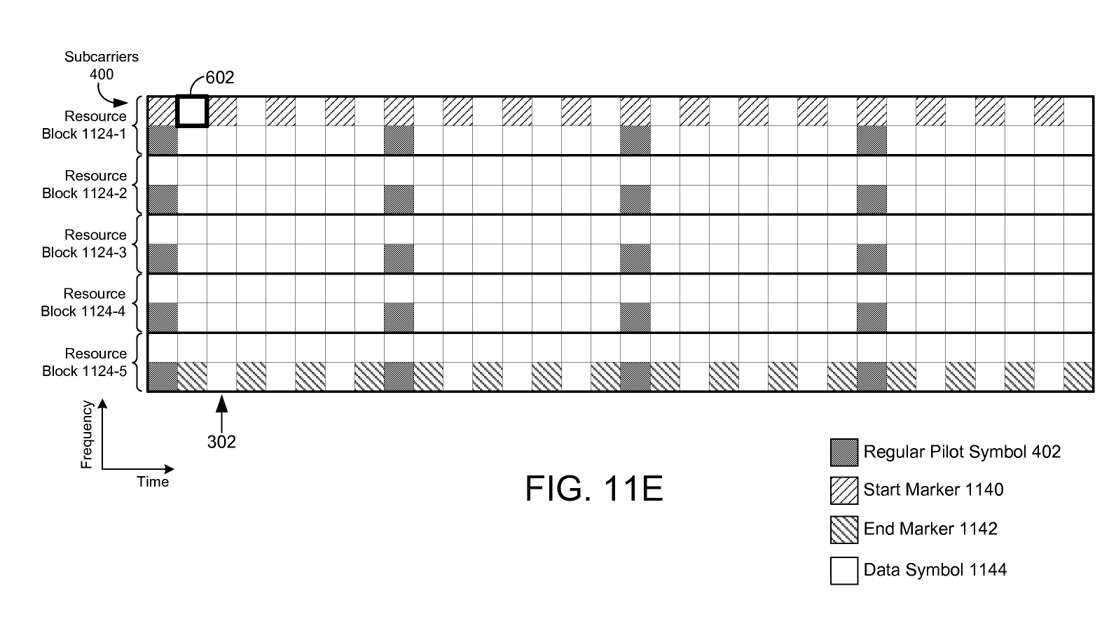

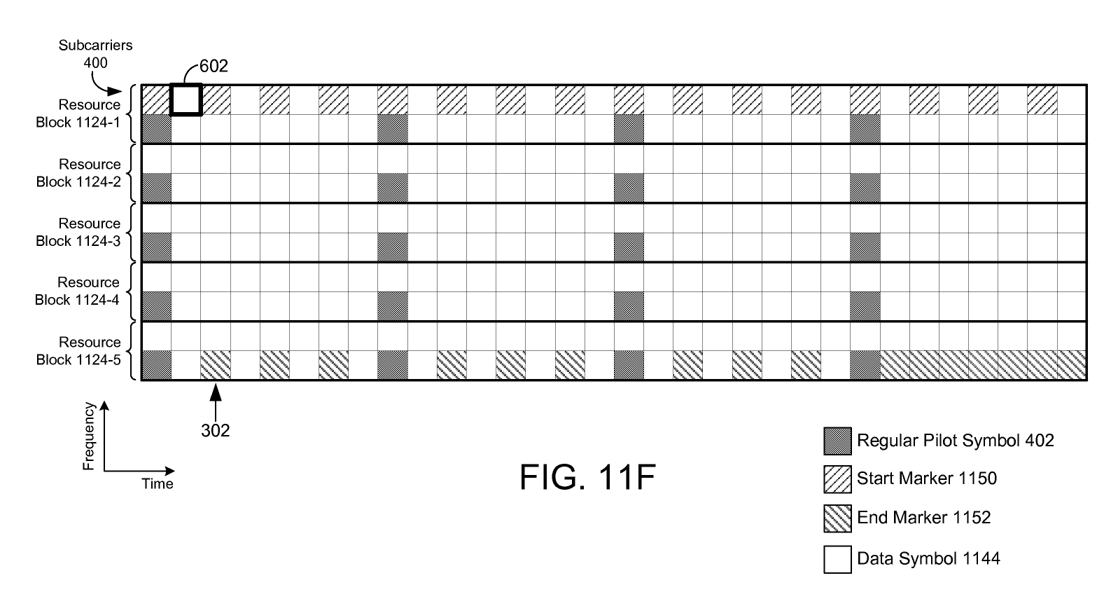

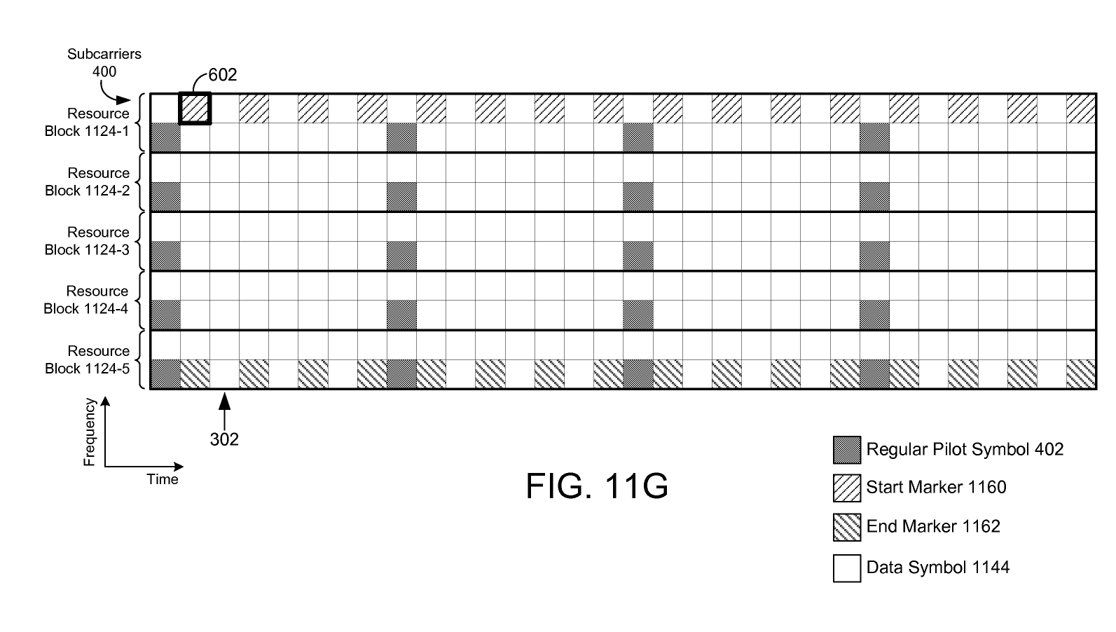

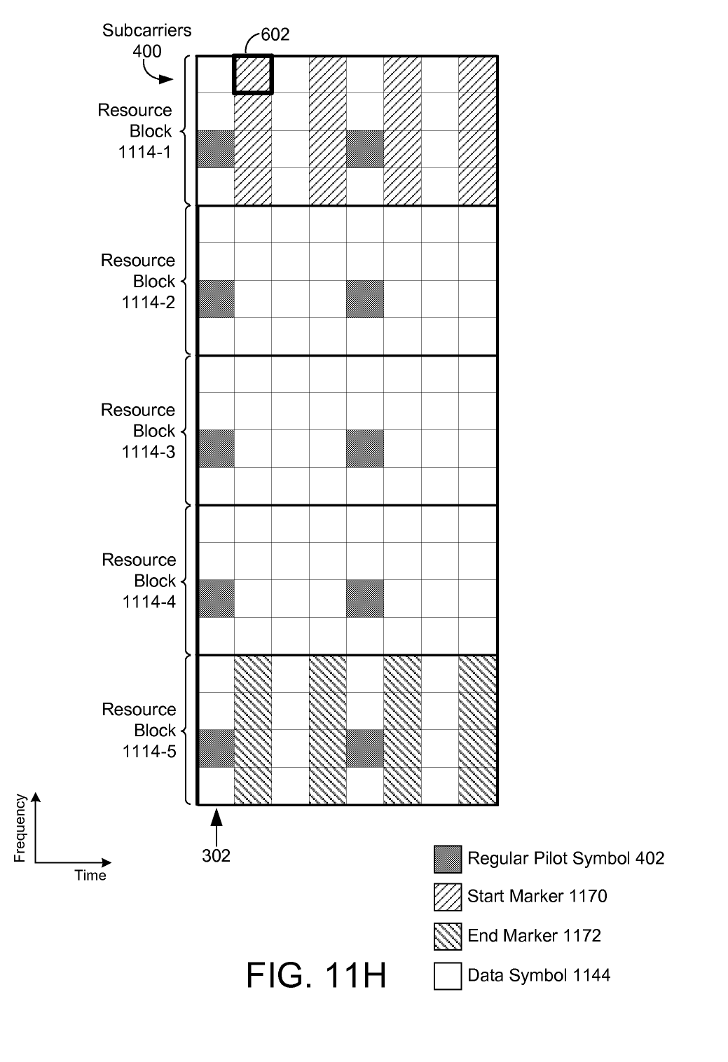

FIGS. 11A-11H show examples of grants with start and end markers as well as regular pilot symbols 402 in accordance with some embodiments. In these examples, each marker includes a specified number of resource elements 602 (e.g., 16 resource elements 602).

In FIG. 11A, a first grant in a (sub)frame allocates resource blocks 1104-1 and 1104-2 to a first CNU 140 and a second grant in the (sub)frame allocates resource blocks 1104-3, 1104-4, and 1104-5 to a second CNU 140. A start marker 1100 is placed on the top subcarrier 400 of resource block 1104-1 in each OFDM symbol 302 of the (sub)frame. An end marker 1102 is placed on the bottom subcarrier 400 of resource block 1104-2 in each OFDM symbol 302 of the (sub)frame. Another start marker 1100 is placed on the top subcarrier 400 of resource block 1104-3 in each OFDM symbol 302 of the (sub)frame, and another end marker 1102 is placed on the bottom subcarrier 400 of resource block 1104-5 in each OFDM symbol 302 of the (sub)frame. In this manner, start markers 1100 and end markers 1102 are included in both the first and second grants. Evenly spaced regular pilot symbols 402 are also included in the first and second grants as shown. In this example, the specified number of resource elements 602 for the start markers 1100 and end markers 1102 equals the number of OFDM symbols 302 in the (sub)frame, and no regular pilot symbols 402 are present in the first and last subcarriers of the grants.

In FIG. 11B, a grant allocates resource blocks 1114-1 through 1114-5 to a particular CNU 140. In this example, the specified number of resource elements 602 for a start marker 1110 and for an end marker 1112 is greater than the number of OFDM symbols 302 in the resource blocks 1114-1 through 1114-5 and thus in the (sub)frame. Also, the start marker 1110 and end marker 1112 are placed such that they do not overwrite any regular pilot symbols 402. Accordingly, the start marker 1110 and end marker 1112 are placed on multiple respective subcarriers 400 at the beginning and end of the grant. The start marker 1110 is placed in all the resource elements 602 for the top two subcarriers 400 of resource block 1114-1. The end marker 1112 is placed in all the resource elements 602 for the bottom two subcarriers 400 of resource block 1114-5 except for the resource elements 602 that carry regular pilot symbols 402. Because there are two resource elements 602 in the second subcarrier 400 from the bottom of resource block 1114-5, the end marker 1112 is also placed in two resource elements 602 (e.g., corresponding to two successive OFDM symbols 302) in the third subcarrier 400 from the bottom of resource block 1114-5. The start marker 1110 therefore may not be symmetric with the end marker 1112 in accordance with some embodiments. Evenly spaced regular pilot symbols 402 are included in the grant as shown.

In FIG. 11C, a grant allocates resource blocks 1124-1 through 1124-5 to a particular CNU 140. In this example, the specified number of resource elements 602 for a start marker 1120 and an end marker 1122 is less than the number of OFDM symbols 302 in the resource blocks 1124-1 through 1124-5 and thus in the (sub)frame. Also, the start marker 1120 and end marker 1122 are placed such that they do not overwrite any regular pilot symbols 402. Accordingly, the start marker 1120 is placed on a subset of the resource elements 602 in the top subcarrier 400 of resource block 1124-1 and the end marker 1122 is placed on a subset of the resource elements 602 in the bottom subcarrier 400 of resource block 1124-5. In some embodiments, the resource elements 602 for each of the start marker 1120 and end marker 1122 are grouped together. For example, the resource elements 602 for the start marker 1120 are grouped in successive OFDM symbols 302, while the resource elements 602 for the end marker 1122 are grouped in a manner that does not overwrite any regular pilot symbols 402. Evenly spaced regular pilot symbols 402 are included in the grant as shown.

In the example of FIG. 11D, the start marker 1130 and end marker 1132 are each at least as long as the number of OFDM symbols 302 in the resource blocks 1124-1 through 1124-5. A grant allocates the resource blocks 1124-1 through 1124-5 to a particular CNU 140. Evenly spaced regular pilot symbols 402 are included in the grant as shown. The start marker 1130 is placed on every resource element 602 of the top subcarrier 400 of resource block 1124-1. The bottom subcarrier of resource block 1124-5, however, includes regular pilot symbols 402. The end marker 1132 is placed on every resource element 602 that does not carry a regular pilot symbol 402 in the bottom subcarrier of resource block 1124-5 and in a group of resource elements 602 on the penultimate subcarrier 400 of resource block 1124-5. FIG. 11D, like FIGS. 11A and 11B, thus effectively shows a continual pilot symbol on each edge of the grant. In some embodiments, the start and end markers 1130 and 1132 (or the combination of the start and end markers 1130 and 1132 and regular pilot symbols 402) provide a continual pilot symbol on each edge of each grant when each start marker 1130 and end marker 1132 is at least as long as the number of OFDM symbols 302 in the resource blocks 1124-1 through 1124-5.

In FIGS. 11E, 11F, and 11G, a grant again allocates resource blocks 1124-1 through 1124-5 to a particular CNU 140. A start marker 1140 (FIG. 11E), 1150 (FIG. 11F), or 1160 (FIG. 11G) is placed on the top subcarrier 400 of resource block 1124-1 and an end marker 1142 (FIG. 11E), 1152 (FIG. 11F), or 1162 (FIG. 11G) is placed on the bottom subcarrier 400 of resource block 1124-5. Each of these markers is shorter than the number of OFDM symbols 302 in the resource blocks 1124-1 through 1124-5. The resource elements 602 for respective markers are distributed across resource elements 602 for subcarriers 400 at the edges of grants, without overwriting regular pilot symbols 402. In some embodiments, the resource elements 602 for a start marker 1140 are staggered (e.g., interleaved) in time with the resource elements 602 for a corresponding end marker 1142, as shown in FIG. 11E. In some embodiments, at least some of the OFDM symbols 302 used for a start marker 1150 are also used for a corresponding end marker 1152, as shown in FIG. 11F. In FIG. 11F, the bottom subcarrier 400 of resource block 1124-5 includes regular pilot symbols 402, while the top subcarrier 400 of resource block 1124-1 does not. The end marker 1152 therefore further uses some OFDM symbols 302 that the start marker 1150 does not use, to maintain an equal number of resource elements 602 in the start marker 1150 and end marker 1152. In some embodiments, the same OFDM symbols 302 are used for the start marker 1160 and end marker 1162, as shown in FIG. 11G.

In FIGS. 11E, 11F, and 11G, marker symbols in the start markers 1140, 1150, and 1160 and end markers 1142, 1152, and 1162 are interleaved with data symbols 1144 in the first and last subcarriers 400 (or portion thereof, for the end marker 1152 of FIG. 11F) of a grant. FIG. 11H shows marker symbols in a start marker 1170 and end marker 1172 interleaved with data symbols 1144 in multiple subcarriers 400 at both the beginning and end of a grant (e.g., the first four subcarriers 400 and last four subcarriers 400 of the grant). The marker symbols for the start marker 1170 and end marker 1172 may be placed on the same OFDM symbols 302 (as shown in FIG. 11H), on different (e.g., staggered) OFDM symbols 302, or on groups of OFDM symbols 302 that partially overlap.

In some embodiments, a grant may extend across a frame boundary, or even across multiple frames. Furthermore, the MAC 206 (FIG. 2) in the CLT 162 may not be frequency aware. In such cases, a grant is not bounded by two markers within a frame, resulting in extrapolation of the channel impulse response (i.e., of the channel estimate) on at least one side of the frequency spectrum. To avoid extrapolation and ensure the presence of time-tracking capability, continual pilot symbols may be introduced at the edges of the frequency spectrum.

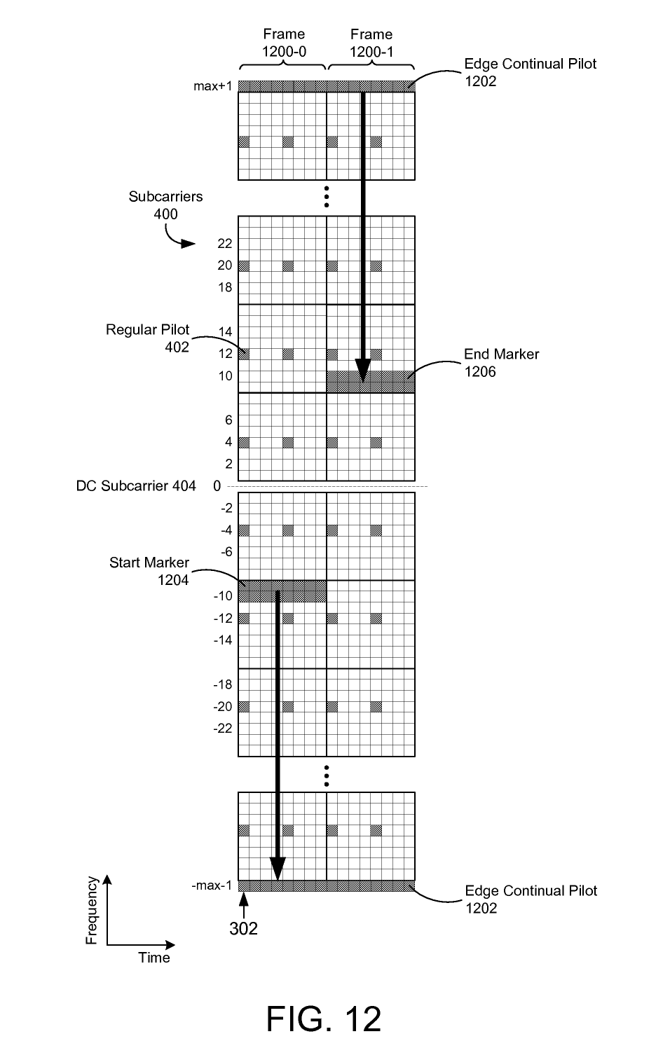

FIG. 12 shows a frame structure with continual pilot symbols 1202 at both edges of the frequency spectrum (“edge continual pilot symbols 1202” or “edge continual pilots 1202” for short) in accordance with some embodiments. The edge continual pilot symbols 1202 are outside of the subcarriers 400 available for allocation: if the available subcarriers 400 range between a subcarrier max and a subcarrier −max, the edge continual pilot symbols 1202 are on subcarriers max+1 and −max−1. The edge continual pilot symbols 1202 thus do not affect addressing of resource blocks and may be unknown to the MAC 206 and/or MAC 218 (FIG. 2). A respective edge continual pilot symbol 1202 for a respective frame 1200-0 or 1200-1 is transmitted by the CNU 140 that has a grant which crosses the frame boundary. In some embodiments, if there is no grant that crosses a frame boundary, no edge continual pilot symbol 1202 is transmitted, because it is not needed.

In FIG. 12, a CNU 140 has a grant the crosses the boundary between frame 1200-0 and frame 1200-1. The grant starts with subcarrier −9 in frame 1200-0 and ends with subcarrier 9 in frame 1200-1. A start marker 1204 for the grant is present in frame 1200-0 and an end marker 1206 for the grant is present in frame 1200-1. The CNU 140 that has the grant transmits edge continual pilot symbols 1202 (e.g., on subcarriers −max−1 in frame 1200-0 and max+1 in frame 1200-1).

In some embodiments, edge continual pilot symbols 1202 are also used in downstream transmissions from the CLT 162 to CNUs 140.

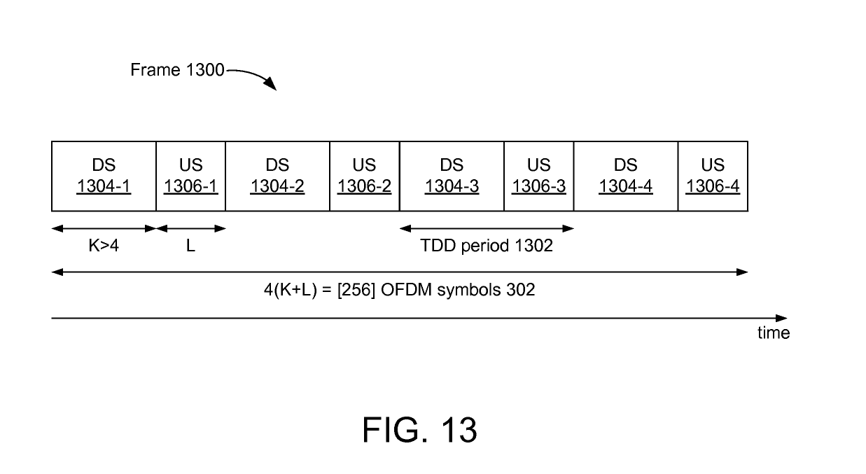

A frame may have a duration of one or more (e.g., one, two, four, six, or eight) TDD periods. FIG. 13 shows four TDD periods 1302 that correspond to a single frame 1300 in accordance with some embodiments. Each TDD period 1302 includes a downstream (DS) transmission period 1304 (e.g., 1304-1, 1304-2, 1304-3, or 1304-4) and an upstream (US) transmission period 1306 (e.g., 1306-1, 1306-2, 1306-3, or 1306-4). (Each TDD period 1302 also includes switching times, which are not shown in FIG. 13 for simplicity.) The downstream and upstream transmission periods 1304 and 1306 may vary from TDD period 1302 to TDD period 1302, although the total TDD period 1302 may remain fixed. In some embodiments, the TDD period 1302 is configurable but does not change dynamically. In the example of FIG. 13, each downstream transmission period 1304 includes K OFDM symbols 302 and each upstream transmission period 1306 includes L OFDM symbols 302, where K is an integer greater than (or greater than or equal to) 4 and L is an integer greater than or equal to one. In this example, each TDD period 1302 has 64 OFDM symbols 302 (K+L=64) and the entire frame has 256 OFDM symbols 302.

In a first mode of operation, the first downstream transmission period 1304-1 includes regular pilot symbols 402 (e.g., in accordance with frame types 1a, 1b, or 1c, FIGS. 3A-3C) but subsequent downstream transmission periods 1304-2, 1304-3, and 1304-4 do not (e.g., in accordance with frame type 2, FIG. 3D). More generally, in the first mode the first downstream transmission period 1304-1 includes regular pilot symbols 402 but subsequent downstream transmission periods 1304 for the frame 1300 do not. In a second mode of operation, every downstream transmission period 1304 for the frame 1300 includes regular pilot symbols 402.

In some embodiments, the upstream transmission periods 1306-1, 1306-2, 1306-3, and 1306-4 include transmissions as shown in FIG. 10C, FIGS. 11A-11F, and/or FIG. 12. The upstream transmission periods 1306-1, 1306-2, 1306-3, and 1306-4 therefore include regular pilot symbols 402 but not continual pilot symbols 304 in accordance with some embodiments, and may also include markers.

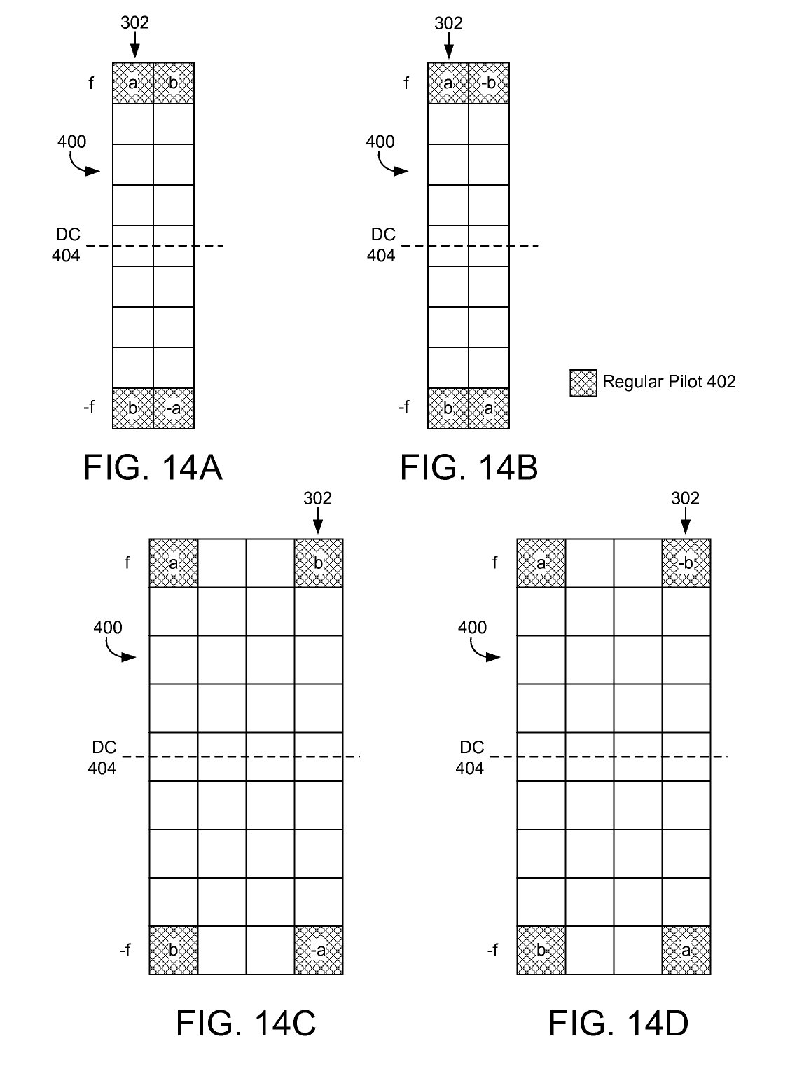

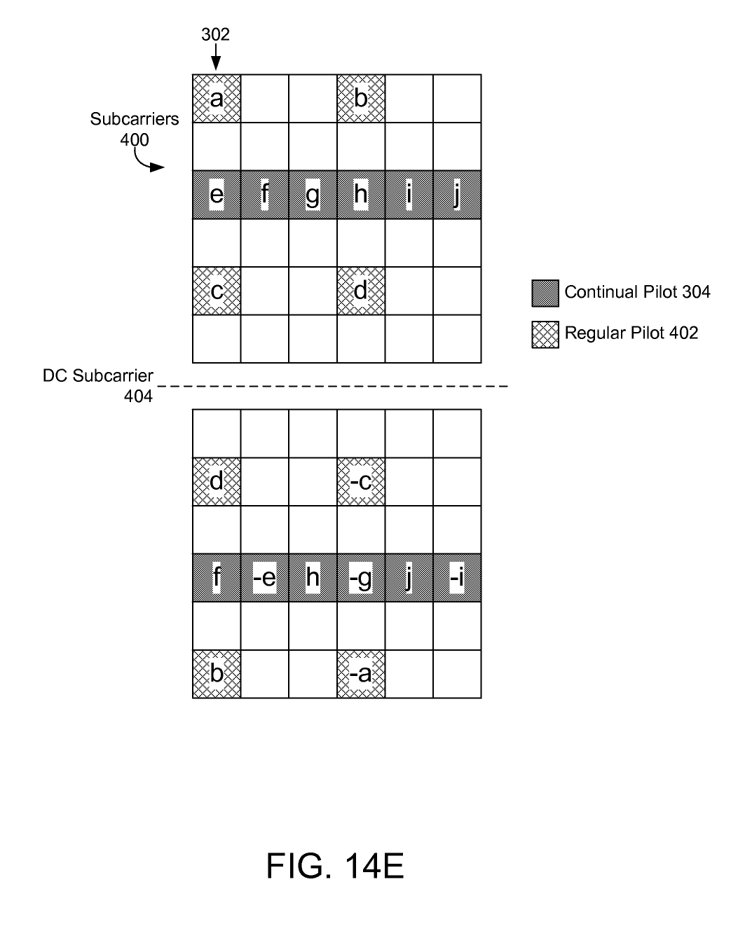

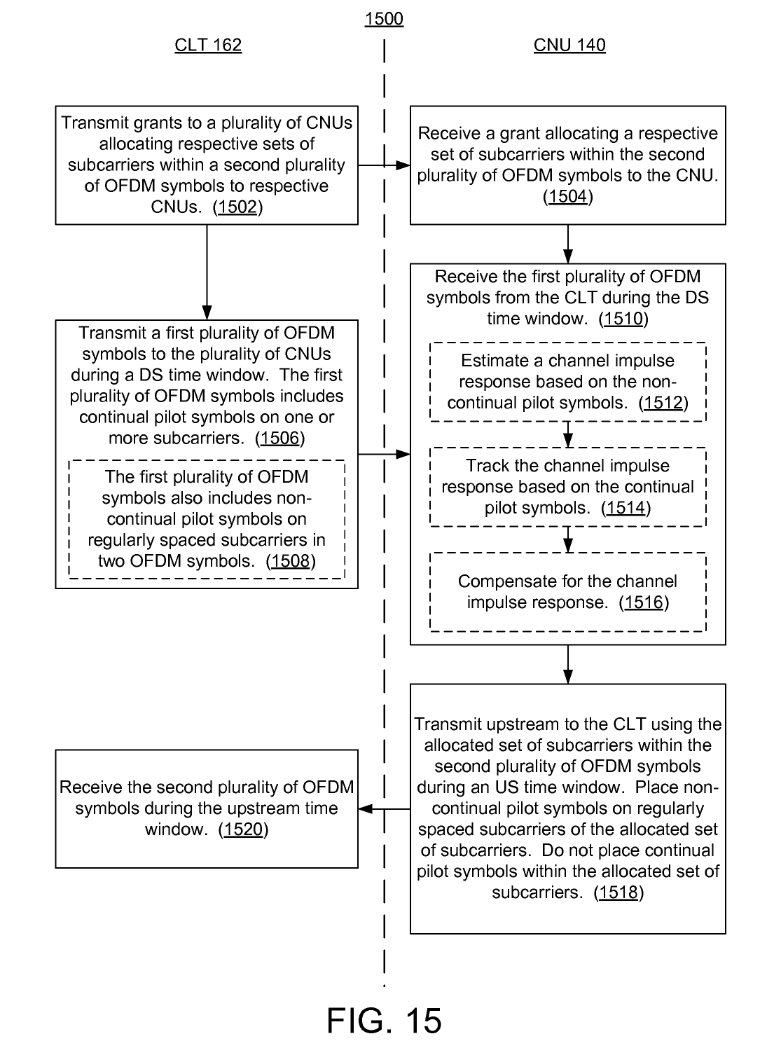

FIGS. 14A-14D show examples of values of regular pilot symbols 402 in accordance with some embodiments. In FIGS. 14A and 14C, a first OFDM symbol 302 has a regular pilot symbol ‘a’ on a subcarrier f and a regular pilot symbol ‘b’ on a subcarrier −f. The subcarriers f and −f are symmetric about the DC subcarrier 404. A second OFDM symbol 302 in the same frame has a regular pilot symbol ‘b’ on the subcarrier f and a regular pilot symbol ‘−a’ on the subcarrier −f. In FIGS. 14B and 14D the first OFDM symbol 302 again has a regular pilot symbol ‘a’ on the subcarrier f and a regular pilot symbol ‘b’ on the subcarrier −f. The second OFDM symbol 302 has a regular pilot symbol ‘−b’ on the subcarrier f and a regular pilot symbol ‘a’ on the subcarrier −f. The second OFDM symbol 302 may be adjacent to the first OFDM symbol 302 or separated from the first OFDM symbol 302 by one or more OFDM symbols 302, as shown. If two OFDM symbols 302 have regular pilot symbols 402 on multiple pairs of symmetric subcarriers 400, the regular pilot symbols 402 for each pair of symmetric subcarriers 400 may be chosen in accordance with FIGS. 14A and 14C or FIGS. 14B and 14D.

FIG. 14E show an example of values of regular pilot symbols 402 and continual pilot symbols 304 in accordance with some embodiments. The values of the regular pilot symbols 402 are chosen in accordance with FIG. 14C in this example. A first subcarrier 400 has continual pilot symbols ‘e’, ‘f’, ‘g’, ‘h’, ‘i’, and ‘j’ on successive OFDM symbols 302. A second subcarrier 400 that is symmetric with the first subcarrier 400 about the DC subcarrier 404 has continual pilot symbols ‘f’, ‘−e’, ‘h’, ‘−g’, ‘j’, and ‘−i’ on the successive OFDM symbols 302. In another example, the first subcarrier 400 has continual pilot symbols ‘e’, ‘−f’, ‘g’, ‘−h’, ‘i’, and ‘−j’ on the successive OFDM symbols 302 and the second subcarrier 400 has continual pilot symbols ‘f’, ‘e’, ‘h’, ‘g’, ‘j’, and ‘i’ on the successive OFDM symbols 302.

Pilot symbols are thus chosen for respective pairs of OFDM symbols 302. For example, the first OFDM symbol 302 in a pair includes a first pilot symbol on a subcarrier 400 above the DC subcarrier 404 (i.e., on a positive subcarrier 400) and a second pilot symbol on a subcarrier 400 below the DC subcarrier 404 (i.e., on a negative subcarrier 400), and the second OFDM symbol 302 in the pair includes the first pilot symbol on the negative subcarrier 400 and the negative of the second pilot symbol on the positive subcarrier 400. Alternatively, the second OFDM symbol 302 includes the second pilot symbol on the positive subcarrier 400 and the negative of the first pilot symbol on the negative subcarrier 400. The positive and negative subcarriers 400 are evenly spaced about the DC subcarrier 404 and thus are symmetric with respect to the DC subcarrier 404.

Transmitting PHYs (e.g., coax PHYs 224 in CNUs 140 and/or coax PHY 212 in the CLT 162, FIG. 2) may be configured to generate signals with pilot symbols as described herein.

FIG. 15 is a flowchart showing a method 1500 of communicating between a CLT 162 and a CNU 140 in accordance with some embodiments. In the method 1500, the CLT 162 transmits (1502) grants to a plurality of CNUs 140. The grants allocate respective sets of subcarriers 400 within a second plurality of OFDM symbols 302 to respective CNUs 140. For example, the grants allocate respective sets of one or more resource blocks 1000 (FIG. 10A) or 1010 (FIG. 10B) to respective CNUs 140.

A CNU 140 in the plurality of CNUs 140 receives (1504) a grant allocating a respective set of subcarriers 400 within the second plurality of OFDM symbols 302 to the CNU 140.

The CLT 162 transmits (1506) a first plurality of OFDM symbols 302 to the plurality of CNUs 140 during a downstream time window (e.g., one of the downstream transmission periods 1304-1, 1304-2, 1304-3, and 1304-4, FIG. 13). The first plurality of OFDM symbols 302 includes continual pilot symbols 304 on one or more subcarriers 400 (e.g., in accordance with frame type 2, FIG. 3D). For example, the first plurality of OFDM symbols 302 includes continual pilot symbols 304 on multiple subcarriers 400 that are symmetric about the DC subcarrier 404. In some embodiments, the first plurality of OFDM symbols 302 also includes (1508) non-continual pilot symbols 402 on regularly spaced subcarriers 400 in two OFDM symbols 302 (e.g., in accordance with frame type 1a, 1b, or 1c, FIGS. 3A-3C). For example, the non-continual pilot symbols 402 are symmetric about the DC subcarrier 404. The continual pilot symbols 304 may be placed between respective non-continual pilot symbols 402 (e.g., as shown in FIGS. 4A, 5A, 7B, 9A, and 9B).

In some embodiments, the first plurality of OFDM symbols 302 includes multiple resource blocks (e.g., resource blocks 700, FIGS. 7A-7B), respective sets of which are directed to respective CNUs 140 of the plurality of CNUs 140.

The CNU 140 receives (1510) the first plurality of OFDM symbols from the CLT 162 during the downstream time window.

In some embodiments, the CNU 140 estimates (1512) a channel impulse response based on the non-continual pilot symbols 402 in the first plurality of OFDM symbols 302 and tracks (1514) the channel impulse response based on the continual pilot symbols 304 in the first plurality of OFDM symbols 302. The CNU 140 compensates (1516) for the channel impulse response as estimated in the operation 1512 and tracked in the operation 1514. Furthermore, the CNU 140 may use the continual pilot symbols 304 to track a channel impulse response for a previous frame until the channel impulse response for the current frame has been estimated based on the non-continual pilot symbols 402 (e.g., as situated in an initial subframe of the current frame).

The CNU 140 transmits (1518) upstream to the CLT 162 using the allocated set of subcarriers 400 within the second plurality of OFDM symbols 302 during an upstream time window (e.g., one of the upstream transmission periods 1306-1, 1306-2, 1306-3, and 1306-4, FIG. 13). (The CNU 140 may be one of a number of CNUs 140 transmitting upstream to the CLT 162 using respective allocated sets of subcarriers 400 within the second plurality of OFDM symbols 302.) The CNU 140 places non-continual pilot symbols 402 on regularly spaced subcarriers 400 of the allocated set of subcarriers 400. In some embodiments, the non-continual pilot symbols 402 are placed in regularly spaced OFDM symbols 302 (e.g., as shown in FIGS. 10C and 12). In some embodiments, the non-continual pilot symbols 402 are placed on a single subcarrier 400 in each of a plurality of resource blocks 1000 or 1010 (FIGS. 10A-10B). The CNU 140 does not place continual pilot symbols 304 within the allocated set of subcarriers 400, such that continual pilot symbols 304 are excluded from the allocated set of subcarriers 400.

In some embodiments, a start marker is placed on one or more subcarriers 400 corresponding to a beginning of the grant and an end marker is placed on one or more subcarriers 400 corresponding to an end of the grant (e.g., as shown in FIGS. 11A-11H and FIG. 12). The start marker and end marker may be placed in resource elements 602 that do not carry non-continual pilot symbols 402.

The CLT 162 receives (1520) the second plurality of OFDM symbols during the upstream time window.

While the method 1500 includes a number of operations that appear to occur in a specific order, it should be apparent that the method 1500 can include more or fewer operations. An order of two or more operations may be changed, performance of two or more operations may overlap, and two or more operations may be combined into a single operation.

In the foregoing specification, the present embodiments have been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A method of communication, comprising:
at a coax network unit (CNU) coupled to a coax line terminal (CLT):
receiving a first plurality of orthogonal frequency-division multiplexing (OFDM) symbols from the CLT, the first plurality of OFDM symbols comprising continual pilot symbols on one or more subcarriers;
receiving a grant from the CLT allocating a set of subcarriers within a second plurality of OFDM symbols to the CNU; and
transmitting upstream to the CLT using the allocated set of subcarriers within the second plurality of OFDM symbols, the transmitting comprising placing non-continual pilot symbols on regularly spaced subcarriers of the allocated set of subcarriers and excluding placing continual pilot symbols within the allocated set of subcarriers.

2. The method of claim 1, wherein:
the first plurality of OFDM symbols are received from the CLT during a downstream time window; and
the second plurality of OFDM symbols are transmitted upstream to the CLT during an upstream time window.

3. The method of claim 1, wherein the first plurality of OFDM symbols further comprises non-continual pilot symbols on regularly spaced subcarriers in two OFDM symbols.

4. The method of claim 3, wherein the two OFDM symbols comprise an initial OFDM symbol of the first plurality of OFDM symbols and a second OFDM symbol immediately following the initial OFDM symbol.

5. The method of claim 3, wherein the two OFDM symbols comprise an initial OFDM symbol of the first plurality of OFDM symbols and a final OFDM symbol of the first plurality of OFDM symbols.

6. The method of claim 3, wherein the two OFDM symbols comprise an initial OFDM symbol of the first plurality of OFDM symbols and a second OFDM symbol separated from the initial OFDM symbol by one or more OFDM symbols.

7. The method of claim 3, wherein:
the non-continual pilot symbols in the first plurality of OFDM symbols are symmetric about a DC subcarrier;
the first plurality of OFDM symbols comprises continual pilot symbols on a plurality of subcarriers; and
the continual pilot symbols in the first plurality of OFDM symbols are symmetric about the DC subcarrier.

8. The method of claim 7, wherein the continual pilot symbols are placed between respective non-continual pilot symbols in the first plurality of OFDM symbols.

9. The method of claim 7, wherein the one or more subcarriers for the continual pilot symbols include subcarriers that is also part of the regularly spaced subcarriers for the non-continual pilot symbols.

10. The method of claim 3, further comprising:
estimating a channel impulse response based on the non-continual pilot symbols in the first plurality of OFDM symbols; and
tracking the channel impulse response based on the continual pilot symbols in the first plurality of OFDM symbols.

11. The method of claim 10, further comprising compensating for the channel impulse response.

12. The method of claim 10, wherein:
the first plurality of OFDM symbols composes a plurality of subframes in a current frame;
the estimating comprises estimating a channel impulse response for the current frame; and
the method further comprises tracking a channel impulse response for a previous frame, based on continual pilot symbols in an initial subframe of the current frame.

13. The method of claim 1, wherein the transmitting comprises placing the non-continual pilot symbols of the second plurality of OFDM symbols on the regularly spaced subcarriers of the allocated set of subcarriers in regularly spaced OFDM symbols of the second plurality of OFDM symbols.

14. The method of claim 1, wherein:
the grant allocates multiple resource blocks to the CNU, each resource block corresponding to a respective subset of the allocated set of subcarriers within the second plurality of OFDM symbols; and
the placing comprises placing the non-continual pilot symbols on a single subcarrier in each of the multiple resource blocks.

15. The method of claim 1, wherein the transmitting further comprises:
placing a start marker on one or more subcarriers corresponding to a beginning of the grant; and
placing an end marker on one or more subcarriers corresponding to an end of the grant.

16. The method of claim 1, wherein the start marker and end marker are placed in resource elements that do not carry pilot symbols.

17. A CNU, comprising:
a coax physical-layer device (PHY) configured to:
receive a first plurality of OFDM symbols, the first plurality of OFDM symbols comprising continual pilot symbols on one or more subcarriers;
receive a grant allocating a set of subcarriers within a second plurality of OFDM symbols to the CNU; and
transmit upstream using the allocated set of subcarriers within the second plurality of OFDM symbols,
wherein, within the allocated set of subcarriers, the second plurality of OFDM symbols comprises non-continual pilot symbols on regularly spaced subcarriers and excludes continual pilot symbols.

18. The CNU of claim 17, wherein the coax PHY is to receive the first plurality of OFDM symbols during a downstream time window and to transmit upstream using the allocated set of subcarriers within the second plurality of OFDM symbols during an upstream time window.

19. The CNU of claim 17, wherein the first plurality of OFDM symbols further comprises non-continual pilot symbols on regularly spaced subcarriers in two OFDM symbols.

20. The CNU of claim 19, wherein:
the non-continual pilot symbols in the first plurality of OFDM symbols are symmetric about a DC subcarrier;
the first plurality of OFDM symbols comprises continual pilot symbols on a plurality of subcarriers; and
the continual pilot symbols in the first plurality of OFDM symbols are symmetric about the DC subcarrier.

21. The CNU of claim 19, wherein the CNU is configured to estimate a channel impulse response based on the non-continual pilot symbols in the first plurality of OFDM symbols and to track the channel impulse response based on the continual pilot symbols in the first plurality of OFDM symbols.

22. The CNU of claim 17, wherein the PHY is configured to place the non-continual pilot symbols of the second plurality of OFDM symbols on the regularly spaced subcarriers of the allocated set of subcarriers in regularly spaced OFDM symbols of the second plurality of OFDM symbols.

23. The CNU of claim 17, wherein the PHY is configured to place within the second plurality of OFDM symbols a start marker on one or more subcarriers corresponding to a beginning of the grant and an end marker on one or more subcarriers corresponding to an end of the grant.

24. A CNU, comprising:
means for receiving a first plurality of OFDM symbols and for receiving a grant allocating a set of subcarriers within a second plurality of OFDM symbols to the CNU, wherein the first plurality of OFDM symbols comprises continual pilot symbols on one or more subcarriers; and
means for transmitting upstream using the allocated set of subcarriers within the second plurality of OFDM symbols, the means for transmitting comprising means for placing non-continual pilot symbols on regularly spaced subcarriers of the allocated set of subcarriers and excluding placing continual pilot symbols within the allocated set of subcarriers.

25. The CNU of claim 24, wherein:
the means for receiving comprise means for receiving the first plurality of OFDM symbols during a downstream time window; and
means for transmitting comprise means for transmitting upstream using the allocated set of subcarriers within the second plurality of OFDM symbols during an upstream time window.

26. The CNU of claim 24, wherein the first plurality of OFDM symbols further comprises non-continual pilot symbols on regularly spaced subcarriers in two OFDM symbols.

27. The CNU of claim 24, wherein the means for placing comprises means for placing the non-continual pilot symbols in regularly spaced OFDM symbols of the second plurality of OFDM symbols.

28. A method of communication, comprising:
at a CLT coupled to a plurality of CNUs:
transmitting a first plurality of OFDM symbols to the plurality of CNUs, the first plurality of OFDM symbols comprising continual pilot symbols on one or more subcarriers;
transmitting grants to the plurality of CNUs allocating respective sets of subcarriers within a second plurality of OFDM symbols to respective CNUs of the plurality of CNUs; and
receiving the second plurality of OFDM symbols, the allocated sets of subcarriers within the second plurality of OFDM symbols comprising non-continual pilot symbols on regularly spaced subcarriers and excluding continual pilot symbols.

29. The method of claim 28, wherein:
the first plurality of OFDM symbols are transmitted to the plurality of CNUs during a downstream time window; and
the second plurality of OFDM symbols are received during an upstream time window.

30. The method of claim 28, wherein the first plurality of OFDM symbols further comprises non-continual pilot symbols on regularly spaced subcarriers in two OFDM symbols.

31. The method of claim 28, wherein the non-continual pilot symbols in the second plurality of OFDM symbols are situated in regularly spaced OFDM symbols.

32. The method of claim 28, wherein the receiving comprises, for each grant, receiving a start marker corresponding to a beginning of the grant on one or more subcarriers within the second plurality of OFDM symbols.

33. A CLT, comprising:
a coax physical-layer device (PHY) configured to:
transmit a first plurality of OFDM symbols to a plurality of CNUs, the first plurality of OFDM symbols comprising continual pilot symbols on one or more subcarriers;
transmit grants to the plurality of CNUs allocating respective sets of subcarriers within a second plurality of OFDM symbols to respective CNUs of the plurality of CNUs; and
receive the second plurality of OFDM symbols, the allocated sets of subcarriers within the second plurality of OFDM symbols comprising non-continual pilot symbols on regularly spaced subcarriers and excluding continual pilot symbols.

34. The CLT of claim 33, wherein the coax PHY is to transmit the first plurality of OFDM symbols to the plurality of CNUs during a downstream time window and to receive the second plurality of OFDM symbols during an upstream time window.

35. The CLT of claim 33, wherein the first plurality of OFDM symbols further comprises non-continual pilot symbols on regularly spaced subcarriers in two OFDM symbols of the first plurality of OFDM symbols.

36. The CLT of claim 33, wherein the non-continual pilot symbols in the second plurality of OFDM symbols are situated in regularly spaced OFDM symbols.

37. The CLT of claim 33, wherein the PHY is configured to identify, for each grant, a start marker corresponding to a beginning of the grant on one or more subcarriers within the second plurality of OFDM symbols.

38. A CLT, comprising:
means for transmitting a first plurality of OFDM symbols to a plurality of CNUs and for transmitting grants to the plurality of CNUs allocating respective sets of subcarriers within a second plurality of OFDM symbols to respective CNUs of the plurality of CNUs, the means for transmitting comprising means for placing continual pilot symbols on one or more subcarriers in the first plurality of OFDM symbols; and
means for receiving the second plurality of OFDM symbols, the allocated sets of subcarriers within the second plurality of OFDM symbols comprising non-continual pilot symbols on regularly spaced subcarriers and excluding continual pilot symbols.

39. The CLT of claim 38, wherein:
the means for transmitting further comprise means for transmitting the first plurality of OFDM symbols to the plurality of CNUs during a downstream time window; and
the means for receiving comprise means for receiving the second plurality of OFDM symbols during an upstream time window.

40. The CLT of claim 38, wherein the means for transmitting further comprise means for placing non-continual pilot symbols on regularly spaced subcarriers in two OFDM symbols of the first plurality of OFDM symbols.

41. The CLT of claim 38, wherein the non-continual pilot symbols in the second plurality of OFDM symbols are situated in regularly spaced OFDM symbols.
